(19) United States
(12) Patent Application Publication
(10) Pub. No.: US 2006/0220809 A1
(43) Pub. Date: Oct. 5, 2006

(54) System and method for monitoring use of vehicles such as golf carts

(75) Inventors: Robert E. Stigall, Plano, TX (US); Dan R. Nelson, Grange (IE)

Correspondence Address: DOCKET CLERK, P.O. DRAWER 800889, DALLAS, TX, 75380, US

(73) Assignee: RF Monolithics, Inc., Dallas, TX (US)

(21) Appl. No.: 11/257,529

(22) Filed: Oct. 25, 2005

Related U.S. Application Data
(63) Continuation-in-part of application No. 11/084,991, filed on Mar. 21, 2005.
(63) Continuation-in-part of application No. 11/085,427, filed on Mar. 21, 2005.

(51) Int. Cl. B60Q 1/00

(52) U.S. Cl. 340/438; 370/351; 340/539.1; 340/5.31

(57) ABSTRACT

A vehicle includes a monitoring system capable of monitoring one or more measurable characteristics associated with the vehicle. The vehicle also includes a transceiver capable of broadcasting information associated with the one or more measurable characteristics for delivery to a controller. The transceiver is also capable of receiving information from at least one of the controller and another vehicle and broadcasting the received information for delivery to a destination other than the vehicle.

### CROSS REFERENCE TO RELATED APPLICATIONS

This application is a continuation-in-part of the following U.S. Patent Applications:

Ser. No. 11/084,991 entitled “System and Method for Synchronizing Components in a Mesh Network,” filed on Mar. 21, 2005; and

Ser. No. 11/085,427 entitled “System and Method for Collecting Routing Information in a Mesh Network,” filed on Mar. 21, 2005; which are hereby incorporated by reference.

### TECHNICAL FIELD

This disclosure relates generally to monitoring systems and more specifically to a system and method for monitoring the use of vehicles such as golf carts.

### BACKGROUND

Golf carts and other types of vehicles are routinely used at country clubs and other facilities to provide transportation services. Many problems typically accompany the use and maintenance of the golf carts and other vehicles. For example, many facilities often hire inexperienced personnel to service and maintain the vehicles. Among other things, tires on the vehicles are often improperly inflated, which may cause excessive wear and tear on the tires and lead to unsafe operating conditions. Also, batteries providing power to the vehicles are typically charged incorrectly, and the conditions of the batteries are not monitored closely. This may shorten the useful lifespan of the batteries and cause the vehicles to stop functioning while still in use.

Other concerns associated with these vehicles typically involve the use of the vehicles. For example, golf carts are often rented, and unauthorized use of the golf carts results in lost revenue. Also, abuse of the vehicles is a concern, such as when users of golf carts operate the carts at excessive speeds on elevated terrains or bump the carts into trees or other objects. This abuse could lead to significant damage to the vehicles, increasing the cost of maintaining the vehicles. In addition, safety of the riders in the vehicles is a concern, such as when golf carts are used by golfers on courses with extreme topography where the golf carts could overturn.

### SUMMARY

This disclosure provides a system and method for monitoring the use of vehicles such as golf carts.

In a first aspect, a vehicle includes a monitoring system capable of monitoring one or more measurable characteristics associated with the vehicle. The vehicle also includes a transceiver capable of broadcasting information associated with the one or more measurable characteristics for delivery to a controller. The transceiver is also capable of receiving information from at least one of the controller and another vehicle and broadcasting the received information for delivery to a destination other than the vehicle.

In a second aspect, a method includes monitoring one or more measurable characteristics associated with a vehicle. The method also includes broadcasting information associated with the one or more measurable characteristics at the vehicle for delivery to a controller. The method further includes receiving information at the vehicle from at least one of the controller and another vehicle. In addition, the method includes broadcasting the received information at the vehicle for delivery to a destination other than the vehicle.

In a third aspect, a computer program is embodied on a computer readable medium and is operable to be executed by a processor. The computer program includes computer readable program code for monitoring one or more measurable characteristics associated with a vehicle. The computer program also includes computer readable program code for broadcasting information associated with the one or more measurable characteristics at the vehicle for delivery to a controller. The computer program further includes computer readable program code for receiving information at the vehicle from at least one of the controller and another vehicle. In addition, the computer program includes computer readable program code for broadcasting the received information at the vehicle for delivery to a destination other than the vehicle.

In a fourth aspect, a vehicle includes a transceiver capable of broadcasting information associated with one or more measurable characteristics of the vehicle for delivery to a controller. The vehicle also includes a monitoring system capable of monitoring the one or more measurable characteristics. The monitoring system includes a plurality of sensors capable of measuring the one or more measurable characteristics associated with the vehicle. The monitoring system also includes a plurality of sensor monitors capable of monitoring the one or more measurable characteristics measured by the plurality of sensors. The monitoring system further includes a vehicle command module controller coupled to the sensor monitors and capable of controlling the broadcasting of the information. In addition, the monitoring system includes a motor controller capable of enabling and disabling operation of a motor in the vehicle. The information associated with the one or more measurable characteristics is capable of identifying one or more problems with the vehicle, misuse of the vehicle, and abuse of the vehicle.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example mesh network according to one embodiment of this disclosure;

FIG. 2 illustrates an example synchronization technique for preventing collisions in a mesh network according to one embodiment of this disclosure;

FIG. 3 illustrates an example collection of routing information in a mesh network according to one embodiment of this disclosure;

FIG. 4 illustrates an example message for initiating collection of routing information in a mesh network according to one embodiment of this disclosure;

FIG. 5 illustrates an example message for reporting collected routing information in a mesh network according to one embodiment of this disclosure;

FIG. 6 illustrates an example link discovery process for collecting routing information in a mesh network according to one embodiment of this disclosure;

FIG. 7 illustrates an example link reporting process for reporting collected routing information in a mesh network according to one embodiment of this disclosure;

FIG. 8 illustrates an example method for collecting routing information in a mesh network at a central controller according to one embodiment of this disclosure;

FIG. 9 illustrates an example method for collecting and reporting routing information at a router in a mesh network according to one embodiment of this disclosure;

FIGS. 10A and 10B illustrate another example method for collecting routing information at a central controller in a mesh network according to one embodiment of this disclosure;

FIGS. 11A and 11B illustrate an example method for collecting routing information at a router in a mesh network according to one embodiment of this disclosure;

FIGS. 12A and 12B illustrate an example method for reporting collected routing information in a mesh network according to one embodiment of this disclosure;

FIG. 13 illustrates an example multi-network mesh network configuration according to one embodiment of this disclosure;

FIG. 14 illustrates an example system for monitoring use of vehicles according to one embodiment of this disclosure;

FIG. 15 illustrates an example cart according to one embodiment of this disclosure;

FIG. 16 illustrates additional details of an example cart according to one embodiment of this disclosure;

FIG. 17 illustrates an example cart tire assembly according to one embodiment of this disclosure;

FIG. 18 illustrates another example cart according to one embodiment of this disclosure; and

FIG. 19 illustrates an example method for monitoring use of vehicles according to one embodiment of this disclosure.

### DETAILED DESCRIPTION

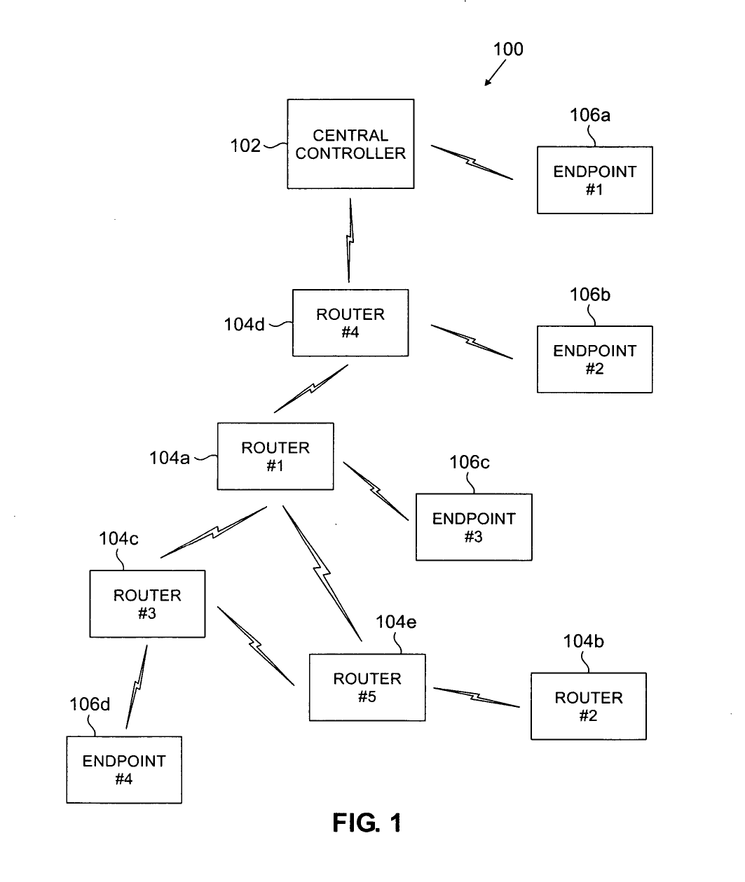

FIG. 1 illustrates an example mesh network 100 according to one embodiment of this disclosure. The embodiment of the mesh network 100 shown in FIG. 1 is for illustration only. Other embodiments of the mesh network 100 may be used without departing from the scope of this disclosure.

In the illustrated example, the mesh network 100 includes a central controller 102, multiple routers 104a-104e, and multiple user endpoints 106a-106d. The central controller 102 communicates with the user endpoints 106a-106d directly or through the routers 104a-104e. The central controller 102 also performs any of a wide variety of additional functions in the mesh network 100. For example, the central controller 102 could provide remote access to a database, and the central controller 102 may store data from the user endpoints 106a-106d and retrieve data for the user endpoints 106a-106d.

The central controller 102 includes any hardware, software, firmware, or combination thereof for collecting and using routing information about the mesh network 100. As a particular example, the central controller 102 may include one or more processors and one or more memories capable of storing instructions executed by the processors and data used by the processors. The central controller 102 may also include a radio frequency antenna and transceiver capable of communicating with the routers 104a-104e and/or the user endpoints 106a-106d using radio frequency signals.

The routers 104a-104e communicate and transport information between the central controller 102 and the user endpoints 106a-106d. For example, the routers 104a-104e may receive information from the central controller 102 and transmit the information to the user endpoints 106a-106d or to other routers 104a-104e for transmission to the user endpoints 106a-106d. The routers 104a-104e may also receive information from the user endpoints 106a-106d and transmit the information to the central controller 102 or to other routers 104a-104e for transmission to the central controller 102. Each router is typically capable of establishing a communication link with all of the other routers, but the layout of the mesh network 100 usually prevents this from occurring. As a result, each router typically establishes a communication link with some of the other routers. In some embodiments, each of the routers 104a-104e represents a mobile device or a fixed device. In particular embodiments, the mesh network 100 includes some fixed routers and some mobile routers, although other embodiments of the mesh network 100 may be used.

Each of the routers 104a-104e represents any hardware, software, firmware, or combination thereof for routing information through the mesh network 100. As an example, the routers 104a-104e could represent routing devices that receive data and transmit the data to a particular destination, such as another router or a user endpoint. The routers 104a-104e could also represent repeater devices that receive data and transmit the data without identifying a particular destination for the data. As a particular example, each of the routers 104a-104e may include one or more processors and one or more memories capable of storing instructions executed by the processors and data used by the processors. Each of the routers 104a-104e may also include a radio frequency antenna and transceiver capable of communicating with the central controller 102 and the user endpoints 106a-106d using radio frequency signals.

The user endpoints 106a-106d communicate with the central controller 102 directly or through the routers 104a-104e. The user endpoints 106a-106d also perform any of a wide variety of additional functions in the mesh network 100. For example, the user endpoints 106a-106d could represent mobile devices that allow users to access a database of information that is maintained by the central controller 102. In some embodiments, each of the user endpoints 106a-106d represents a mobile device or a fixed device. In particular embodiments, the mesh network 100 includes some fixed user endpoints and some mobile user endpoints, although other embodiments of the mesh network 100 may be used.

The user endpoints 106a-106d may communicate data to the routers 104a-104e in any suitable manner. For example, the user endpoints 106a-106d could repeatedly transmit the same data to the routers 104a-104e. The user endpoints 106a-106d could also respond to queries received over the routers 104a-104e. The user endpoints 106a-106d could communicate in any other suitable manner.

Each of the user endpoints 106a-106d includes any hardware, software, firmware, or combination thereof for transmitting information to and/or receiving information from the central controller 102. As examples, the user endpoints 106a-106d could represent devices such as mobile computing devices such as handheld personal digital assistants, mobile communication devices such as mobile telephones, and fixed communication or computing devices. As a particular example, each of the user endpoints 106a-106d may include one or more processors and one or more memories capable of storing instructions executed by the processors and data used by the processors. Each of the user endpoints 106a-106d may also include a radio frequency antenna and transceiver capable of communicating with the routers 104a-104e using radio frequency signals.

The various components in the mesh network 100 may communicate using any suitable wireless connections. For example, the components may communicate using radio frequency signals. In some embodiments, all components in the mesh network 100 communicate using the same radio frequency. In other embodiments, all components in the mesh network 100 may communicate using a primary radio frequency and, when interference is detected, communicate using a secondary radio frequency.

In one aspect of operation, the central controller 102 collects routing information about the mesh network 100 during a “link discovery” process. For example, the central controller 102 may receive information from the routers 104a-104e identifying communication links between the routers 104a-104e. This information identifies the “visibility” of each router to other routers in the mesh network 100. The routing information may routinely change, for example, when at least some of the routers 104a-104e are mobile. The central controller 102 then uses the routing information to determine how to route information to the user endpoints 106a-106d through the routers 104a-104e.

In some embodiments, the central controller 102 collects routing information by communicating a link request message to any routers in direct communication with the central controller 102 (in this case, router 104d). Each of the routers 104a-104e in the mesh network 100 eventually receives the link request message. Each router then identifies the other routers that are in direct communication with that router. For example, router 104d may determine that it is only receiving a signal from router 104a, while router 104a may determine that it is receiving a signal from routers 104c-104e.

Each of the routers 104a-104e then provides this information to the central controller 102 in a link response message. The link response message contains information identifying the routers that a particular router can detect. For example, a link response message may include a link list, which contains an entry for each of the routers 104a-104e in the mesh network 100. Each entry identifies the routers that are in communication with a specified router in the mesh network 100. As a specific example, the first entry in the link list could identify the routers detected by router 104a, the second entry in the link list could identify the routers detected by router 104b, and so on.

In particular embodiments, each router that receives a link response message consolidates the information from its link list with the link list contained in the link response message. This allows a single link list to contain routing information from multiple routers. In fact, in this example, the central controller 102 would receive only one link response message containing a single link list from the router 104d. The single link list would contain information identifying all of the communication links between the routers 104a-104e in the mesh network 100. However, in other embodiments, the central controller 102 could receive multiple link response messages containing multiple link lists, depending on the layout of the mesh network 100. As an example, if the central controller 102 is in direct communication with two different routers, the central controller 102 could receive a link response message from both of the routers.

After the link discovery process, each of the routers 104a-104e routes information in the mesh network 100, such as information between the central controller 102 and the user endpoints 106a-106d. One or more of the routers 104a-104e may determine that a new router is visible that was not previously visible during the link discovery process. When a first router detects visibility with a new second router, the first router sets a link discovery update flag. When the first router receives a message destined for the central controller 102, the first router embeds in the message an indication that its link discovery update flag has been set. The message is then broadcast for direct or indirect delivery to the central controller 102. The first router may repeat this process for every message received that is destined for the central controller 102. The central controller 102 may maintain a list of which routers 104a-104e have set their link discovery update flag and, based on those flags, determine when to repeat the link discovery process. For example, the central controller 102 may repeat the link discovery process after one-quarter or one-half of the routers 104a-104e have set their link discovery update flag. When the link discovery process is performed, the routers 104a-104e may reset their link discovery update flag.

In another aspect of operation, the central controller 102 collects information about the user endpoints 106a-106d in the mesh network 100 during a “border discovery” process. For example, the central controller 102 may receive information from the routers 104a-104e identifying which user endpoints 106a-106d are in direct communication with each of the routers 104a-104e. This information may routinely change, for example, when at least some of the routers 104a-104e and/or at least some of the user endpoints 106a-106d are mobile. The central controller 102 then uses this information to determine how to route information to the user endpoints 106a-106d.

In some embodiments, the process of border discovery occurs and is integrated into the normal routing of messages between the central controller 102 and the user endpoints 106a-106d. For example, one of the routers 104a-104e may receive a message directly from one of the user endpoints 106a-106d (as opposed to indirectly though another of the routers 104a-104e). The router directly receiving the message from the user endpoint embeds its own unique identifier or other identifier into the message. The router also embeds into the message an indication that the user endpoint is newly visible to the router. The message is then transmitted directly or indirectly to the central controller 102. The central controller 102 receives the message and extracts the identifier associated with the router.

In this way, the central controller 102 may identify the user endpoints 106a-106d in the network 100. Also, the central controller 102 may identify the routers that are in direct communication with those user endpoints 106a-106d. The central controller 102 may use this information in any suitable manner. For example, to transmit a message to a particular one of the user endpoints 106a-106d, the central controller 102 may use the identity of the router in direct communication with that endpoint and the information collected during the link discovery process to determine how to efficiently route the message to the user endpoint. In addition, the central controller 102 may be able to continuously update and monitor the positions of the user endpoints 106a-106d in the mesh network 100.

Depending on the arrangement of the network 100, one of the user endpoints 106a-106d may be directly visible to two or more of the routers 104a-104e. As a result, when the endpoint transmits a message, multiple routers may receive and embed their unique identifiers into different copies of the message and attempt to route the copies of the message to the central controller 102. However, because of the routing process used by the routers 104a-104e, only one copy of the message (containing only one router identifier) may be received by the central controller 102. For example, a router that receives the different copies of the message may recognize that the copies relate to the same message and forward only the earliest-received copy. Other techniques could also be used, such as when all copies of the message are received by the central controller 102 and the central controller 102 records one, some, or all of the router identifiers associated with the user endpoint.

In a third aspect of operation, the central controller 102, the routers 104a-104e, and the user endpoints 106a-106d in the mesh network 100 may communicate using signals that interfere with each other. If two or more components in the mesh network 100 attempt to transmit information in an overlapping manner, a collision may occur, and data from both components may be lost. To help avoid collisions, the components in the mesh network 100 implement a timing scheme to synchronize the components. Synchronized timing allows the components in the mesh network to use a received message to accurately identify time slots in which the components may communicate without overlapping.

In some embodiments, the components in direct communication with the central controller 102 are synchronized with the central controller 102. Additional components in the mesh network 100 are synchronized when those components communicate with the components in direct communication with the central controller 102. As a particular example, the router 104d may be synchronized with the central controller 102 at the beginning of a communication. If router 104d communicates with router 104a, router 104a may synchronize with router 104d. Similarly, if router 104a communicates with router 104c, router 104c may synchronize with router 104a. In this way, synchronization propagates through the mesh network 100, which helps to at least partially reduce collisions in the mesh network 100.

Although FIG. 1 illustrates one example of a mesh network 100, various changes may be made to FIG. 1. For example, the mesh network 100 may include any number of routers 104 and user endpoints 106. Also, the mesh network 100 may have any arrangement of routers 104 and user endpoints 106. Further, while FIG. 1 illustrates the use of wireless communications between the components in the mesh network 100, at least some of the components could communicate using wired connections. In addition, while FIG. 1 has illustrated separate components in the mesh network 100, various components may be combined. As an example, a user endpoint could include a router, and the integrated device may perform both routing and end user functions.

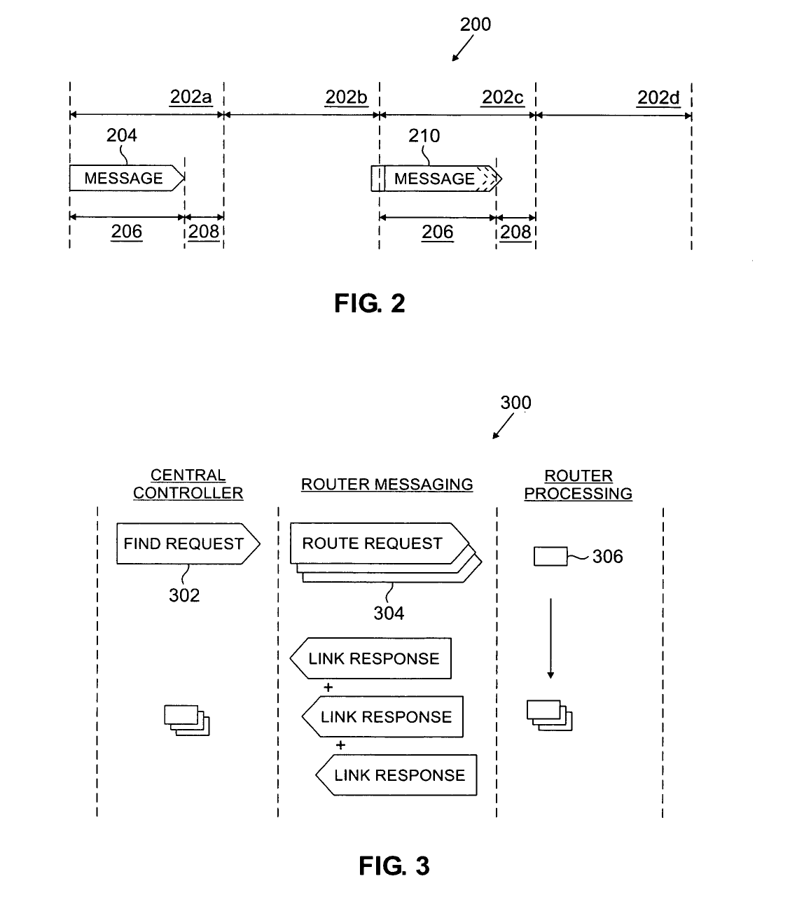

FIG. 2 illustrates an example synchronization technique 200 for preventing collisions in a mesh network according to one embodiment of this disclosure. For ease of explanation, the synchronization technique 200 is described with respect to the mesh network 100 of FIG. 1. The synchronization technique 200 could be used by any other networks without departing from the scope of this disclosure. Also, the mesh network 100 could use other synchronization techniques without departing from the scope of this disclosure.

In this example, the synchronization technique 200 divides communications into multiple time slots 202a-202d. Each of the time slots 202a-202d represents a fixed period of time. The synchronization technique 200 starts when a message 204 is transmitted from the central controller 102. The message 204 itself has a fixed length and requires a fixed time to be transmitted, and this fixed time is referred to as a message time 206. Upon receipt of the message 204, a router (router 104d in FIG. 1) adds a fixed length of additional time 208 to the message time 206. The additional time 208 allows the mesh network 100 to take into account the time needed to process messages by the components in the mesh network 100, as well as variances within the routers 104a-104e. The combination of the message time 206 and the additional time 208 defines the length of the time slot 202a. In some embodiments, the fixed length of additional time 208 is known to all routers 104a-104e and remains constant for all messages regardless of the message time 206.

Subsequent time slots 202b-202d may remain synchronized in any number of ways. In some embodiments, the length of the time slot 202a is stored in an internal register of the router 104d. The value in the register is used to set a slot timer in the router 104d, and the end of the next time slot 202b is identified when the slot timer expires. The value in the register is used to reset the slot timer, and the end of the next time slot 202c is identified when the slot timer expire again. This allows the router 104d to identify the remaining time slots 202b-202d.

The router 104d could also use a valid incoming message 210 from a neighboring router (such as router 104a in FIG. 1). The receipt of the message 210 may or may not occur on the expected boundary of a time slot. If not, the router 104d may re-align or re-synchronize its slot timer. For example, the router 104d may wait for the additional time 208 to elapse after receipt of the message 210, and the router 104d may start the slot timer after expiration of the additional time 208.

The other routers in the mesh network 100 are synchronized in a similar manner. For example, router 104a may receive a message from router 104d. The router 104a may use the message time 206 of that message and the additional time 208 to determine the length of a time slot. The router 104a then uses an internal register to store the length of the time slot and a slot timer to time the time slots. The router 104a may then communicate a message to router 104c and/or router 104e, and either of those routers 104c, 104e may use the same technique. In this way, the time slots may be established in a daisy chain manner throughout the mesh network 100, allowing each router to identify the time slots that may be used to transmit information. This procedure also prevents collisions from occurring in the mesh network 100.

Although FIG. 2 illustrates one example of a synchronization technique 200 for preventing collisions in a mesh network, various changes may be made to FIG. 2. For example, other or additional techniques may be used to synchronize or re-synchronize the routers 104a-104e in the mesh network 100.

FIG. 3 illustrates an example collection 300 of routing information in a mesh network according to one embodiment of this disclosure. For ease of explanation, the collection 300 of routing information is described with respect to the mesh network 100 of FIG. 1. The collection 300 of routing information could be performed by any other networks without departing from the scope of this disclosure. Also, the mesh network 100 could use other collection techniques without departing from the scope of this disclosure.

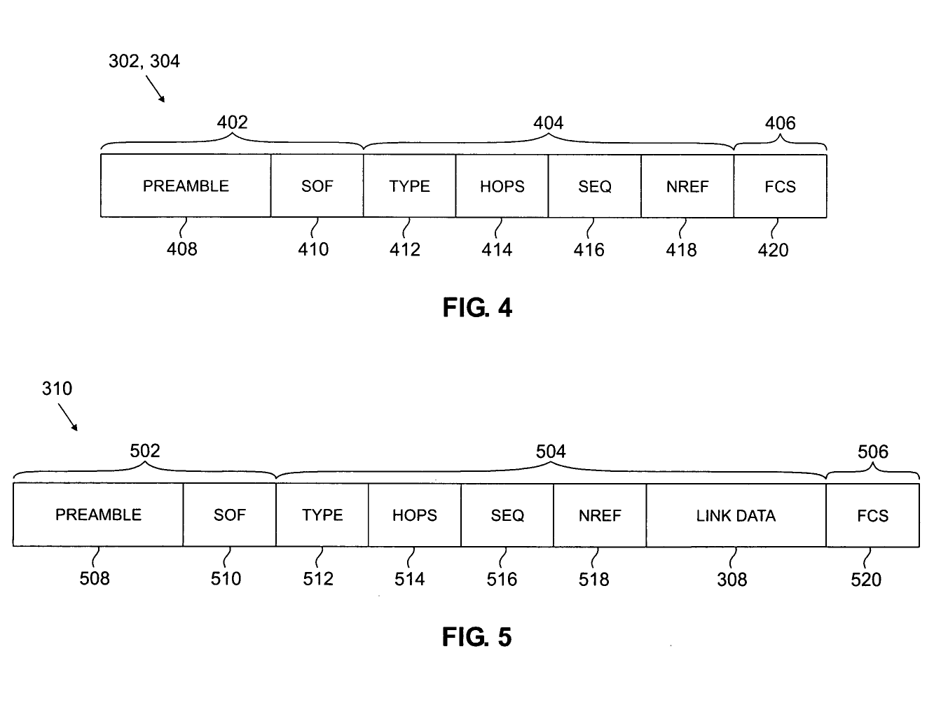

In this example, the collection 300 of routing information in the mesh network 100 begins with a link discovery process. The link discovery process involves the routers 104a-104e identifying all of the communication links that connect the routers. The link discovery process is initiated when the central controller 102 generates and communicates a find link request message 302 to at least one of the routers 104a-104e in the mesh network 100. The find link request message 302 requests that the various routers 104a-104e in the mesh network 100 collect information about visible communication links between the routers and provide this information to the central controller 102. The find link request message 302 may have any suitable contents and format. One example embodiment of the find link request message 302 is shown in FIG. 4, which is described below.

The request for routing information is routed to the routers 104a-104e in the network 100 in the form of route request messages 304. For example, the first router (such as router 104d in FIG. 1) to receive the find link request message 302 from the central controller 102 may transmit a route request message 304 to all other routers (such as router 104a in FIG. 1) in contact with that router 104d. The route request messages 304 may have the same content and arrangement as the find link request message 302, or the messages could have different contents and/or formats.

When a router receives a find link request message 302 or a route request message 304, that router generates a link map 306. The link map 306 identifies the communication links that are visible to the router, such as the communication links to other routers. For example, each find link request message 302 and route request message 304 may identify the source of the message (such as central controller 102 or a router). When a router receives one of these messages, the router may insert the identity of the source into the link map 306. During the collection 300 of routing information, each router may receive multiple route request messages 304, such as route request messages 304 from all other routers that are visible. The source of each of these messages is identified and stored in the link map 306. As the messages 302, 304 propagate through the mesh network 100, each of the routers 104a-104e eventually contains a link map 306 that identifies all other routers that are visible to that router.

In some embodiments, the central controller 102 may limit the number of times the messages 304 are re-broadcast during the link discovery process and/or limit the routers that participate in the link discovery process. For example, the central controller 102 may specify a value that limits the number of times that the same route request message 304 may be forwarded in the mesh network 100, where the value relates to the number of routers 104a-104e currently in the mesh network 100. As a particular example, the central controller 102 may indicate that a route request message 304 cannot be forwarded more than five times in the mesh network 100. In this way, the link discovery process may be achieved more efficiently. Depending on the size and layout of the mesh network 100, this may also prevent at least some of the routers from participating in the link discovery process.

After the link discovery process, the collection 300 of routing information in the mesh network 100 concludes with a link reporting process. The link reporting process involves the routers 104a-104e providing the collected information in the link maps 306 to the central controller 102. Each of the routers 104a-104e generates a link list 308. The link list 308 contains an entry for each router 104a-104e, and the entry for a particular router identifies the communication links visible to that router. The link list 308 in each router initially contains only the information from that router's link map 306. As a result, the link list 308 initially identifies only the other routers visible to one particular router. For example, the link list 308 in router 104a would identify routers 104c-104e since all three routers are visible to router 104a. Similarly, the link list 308 in router 104b would only identify router 104e since only that router 104e is visible to router 104b.

The routers 104a-104e transmit their link lists 308 to the central controller 102 in link response messages 310. The link response messages 310 provide the collected information about visible communication links between the routers to the central controller 102. The link response messages 310 may have any suitable contents and format. One example embodiment of the link response messages 310 is shown in FIG. 5, which is described below.

In some embodiments, each router that receives a link response message 310 from another router consolidates the link list 308 in the message 310 with its own link list 308. A router may receive a link response message 310 from another router and merge or overlay its link list 308 with the link list 308 in the message 310. That router then communicates a link response message 310 containing the aggregate link list to yet another router or to the central controller 102. Eventually, the central controller 102 receives a consolidated link list 312, which contains routing information from multiple routers in the mesh network 100. In particular embodiments, every router that participates in the link discovery process also participates in consolidating its link list 308 with other routers' link lists 308. In these embodiments, the central controller 102 may receive a single consolidated link list 312 containing routing information from every router in the mesh network 100 that participating in the link discovery process.

The communications shown in FIG. 3 may occur in any suitable manner. For example, the communications shown in FIG. 3 may occur in a synchronized, non-contentious fashion using the synchronization technique 200 shown in FIG. 2 and described above. In this way, the routers 104a-104e may participate in the link discovery and link reporting processes with fewer or no collisions during data transmissions.

Although FIG. 3 illustrates one example of the collection 300 of routing information in a mesh network, various changes may be made to FIG. 3. For example, any other or additional types of messages could be used to initiate collection and to report collected information.

FIG. 4 illustrates an example message for initiating collection of routing information in a mesh network according to one embodiment of this disclosure. In particular, FIG. 4 illustrates a find link request message 302 and/or a route request message 304 that is used to initiate collection of routing information in routers 104a-104e in the mesh network 100. The embodiment of the messages 302, 304 shown in FIG. 4 is for illustration only. Other embodiments of the messages 302, 304 may be used without departing from the scope of this disclosure. Also, the different messages 302, 304 could have different structures and/or contents.

In this example, the message 302, 304 includes a header 402, a body 404, and a tail 406. The header 402 includes a preamble 408 and a start of frame (“SOF”) marker 410. The preamble 408 and the SOF marker 410 may contain any suitable information. For example, the preamble 408 could contain bit synchronization information, and the SOF marker 410 could contain character synchronization information. This synchronization information allows the router receiving the message 302, 304 to be synchronized with the bits and characters in the message 302, 304. The preamble 408 and the SOF marker 410 could contain any other or additional information.

The body 404 of the message 302, 304 includes various fields. A type 412 identifies the message type of message 302, 304. For example, the type 412 could identify the message as a find link request message 302 or a route request message 304.

A hops value 414 identifies the number of routers 104a-104e to participate in the link discovery process. The hops value 414 also identifies the maximum number of hops or relays needed for a message from the central controller 102 to reach a router participating in the link discovery process. A sequence (“SEQ”) value 416 identifies the current iteration of the message 302, 304, or the number of times that this message 302, 304 has been received and forwarded during the link discovery process. In some embodiments, the central controller 102 may not know ahead of time how the routers are arranged and how the messages 302, 304 will propagate through the mesh network 100. This is due, for example, to the fact that the routers participating in the link discovery process may have any suitable arrangement and this arrangement may change over time if any of the routers are mobile. The hops value 414 and the sequence value 416 help to ensure that the specified number of routers participate in the link discovery process and that a sufficient number of time slots 202 are allocated so that the routers may receive the messages 302, 304 and respond. In particular embodiments, the hops value 414 remains constant during the link discovery process, while the sequence value 416 is incremented during the link discovery process and is used to determine an end to the link discovery process.

A network reference (“NREF”) value 418 represents a value used to control when the routers participating in the link discovery process transmit data. The network reference value 418 is dynamic and is updated for each new time slot 202. For example, the network reference value 418 could be incremented at each time slot 202 until a maximum value is reached and then decremented at each time slot 202 until a minimum value is reached. In some embodiments, each of the routers 104a-104e has a unique identifier, and a router is allowed to transmit in a time slot 202 only when its unique identifier matches the network reference value 418 for that time slot 202.

The tail 406 of the message 302, 304 includes a frame check sequence (“FCS”) 420. The frame check sequence 420 contains information that is used to validate the message 302, 304. For example, the frame check sequence 420 could contain information allowing the router receiving the message 302, 304 to verify that the message 302, 304 contains no errors.

Although FIG. 4 illustrates one example of a message for initiating collection of routing information in a mesh network, various changes may be made to FIG. 4. For example, the contents and arrangement of the message shown in FIG. 4 are for illustration only. The message could include any other or additional contents in any other arrangement.

FIG. 5 illustrates an example message for reporting collected routing information in a mesh network according to one embodiment of this disclosure. In particular, FIG. 5 illustrates a link response message 310 that is used to report collected routing information from the routers 104a-104e to the central controller 102 in the mesh network 100. The embodiment of the link response messages 310 shown in FIG. 5 is for illustration only. Other embodiments of the link response messages 310 may be used without departing from the scope of this disclosure.

In this example, the message 310 includes a header 502, a body 504, and a tail 506. The header 502 includes a preamble 508 and SOF marker 510. The body 504 includes a type 512, a hops value 514, a sequence value 516, a network reference value 518, and a link list 308. The tail 506 includes a frame check sequence 520. Much of the information in the header 502, body 504, and tail 506 is the same as or similar to information in the header 402, body 404, and tail 406, respectively, from FIG. 4. In this example, the type 508 would identify the message as a link response message 310.

The link list 308 in the link response messages 310 contains the information collected by one or more of the routers 104a-104e and stored in the link map(s) 306 of the router(s). When a router generates the link response messages 310, the router initially populates the link list 308 in the message 310 with the contents of that router's link map 306. The router may or may not receive another router's link response messages 310 before transmitting its own link response messages 310. If the router does receive another router's link response messages 310 before transmitting its own link response messages 310, the router consolidates the link list 308 in the other router's message 310 with the link list 308 in that router's message 310. The router then transmits the message 310 containing the consolidated link list 308.

In particular embodiments, each router transmits its link response messages 310 only once during the link reporting process. Also, the routers 104a-104e may transmit the link response messages 310 during the link reporting process in an order that is reversed from the order in which the routers 104a-104e transmitted the route request messages 304 during the link discovery process.

Although FIG. 5 illustrates one example of a message for reporting collected routing information in a mesh network, various changes may be made to FIG. 5. For example, the contents and arrangement of the message shown in FIG. 5 are for illustration only. The message could include any other or additional contents in any other arrangement.

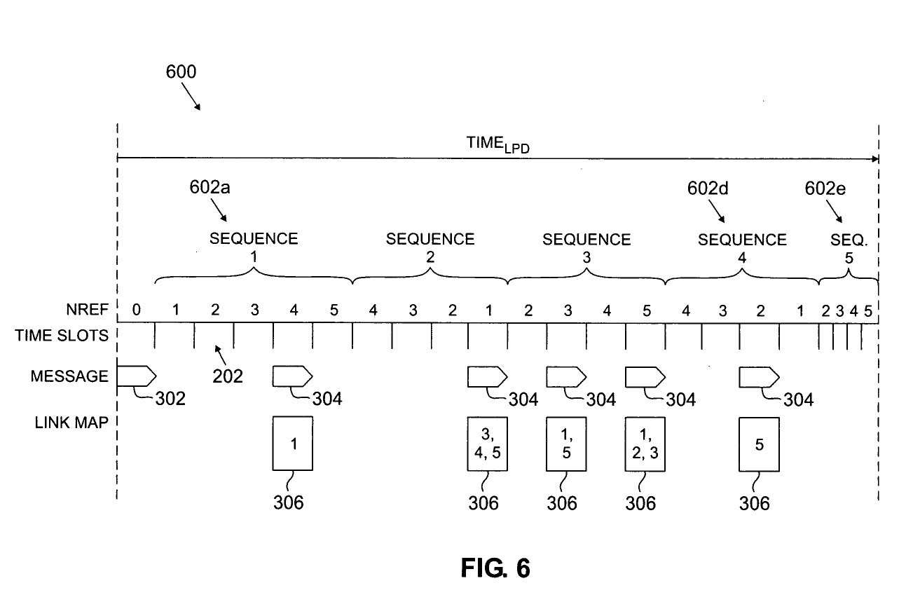

FIG. 6 illustrates an example link discovery process 600 for collecting routing information in a mesh network according to one embodiment of this disclosure. In particular, FIG. 6 illustrates how the messages 302, 304 shown in FIG. 4 are used to initiate collection of routing information in the mesh network 100. The link discovery process 600 shown in FIG. 6 is for illustration only. Other embodiments of the mesh network 100 that operate using different link discovery processes may be used without departing from the scope of this disclosure.

In this example, the link discovery process 600 begins with the central controller 102 generating and communicating a find link request message 302 to at least one router (such as router 104d). In some embodiments, the hops value 414 in the find link request message 302 is set to the number of routers to participate in the link discovery process. For the embodiment of the mesh network 100 shown in FIG. 1, the hops value 414 could be set to a value of five. The sequence value 416 in the find link request message 302 is initialized to a value of one, and the network reference value is initialized to a value of zero. The find link request message 302 is then transmitted during the first time slot 202 shown in FIG. 6.

After the first time slot 202, the central controller 102 begins incrementing the network reference value at each new time slot 202 until a maximum value is reached. After that, the central controller 102 decrements the network reference value at each new time slot 202 until a minimum value is reached. This process is repeated throughout the link discovery process 600.

In FIG. 6, the process of incrementing and decrementing the network reference value is divided into sequences 602a-602e. Each of these sequences 602a-602e represents a period of time where the network reference value is either (a) incremented up to a maximum value or (b) decremented down to a minimum value. In this example, the network reference value may have a value between one and five during the sequences 602a-602e, and these values correspond to routers 104a-104e, respectively. The sequence value 416 in the message 302 is initially set to a value of one, and the sequence value 416 in any route request messages 304 is incremented at each new sequence.

The router 104d is the only router in the mesh network 100 of FIG. 1 that receives the find link request message 302. The router 104d synchronizes with the time slots 202 used by the central controller 102 using the message 302. The router 104d also synchronizes with the network reference value used by the central controller 102. For example, the router 104d may use the network reference value contained in the message 302 and increment or decrement the value at each new time slot 202.

The router 104d compares the network reference value to its unique identifier and waits until those values are equal. For example, the router 104d (referred to as “Router #4”) may have a unique identifier such as a value of four. The router 104d transmits a route request message 304 when the network reference value equals the unique identified for the router 104d. The router 104d also generates a link map 306 identifying all of the routers in the mesh network 100 that are visible to the router 104d. In this example, only router 104a (Referred to as “Router #1” and identified with a value of “1”) is visible to router 104d.

Router 104a receives the route request message 304 from the router 104d. Router 104a synchronizes with the time slots 202 and the network reference value using the received message 304. Router 104a transmits a route request message 304 when the network reference value equals one. Router 104a also generates a link map 306, which indicates that routers 104c-104e are all visible to router 104a.

Routers 104c-104e receive the route request message 304 from the router 104a. Router 104d need not perform any additional actions since it has already generated its link map 306. Routers 104c and 104e synchronize with the time slots 202 and the network reference value using the received message 304. The router 104c (referred to as “Router #3”) transmits a route request message 304 when the network reference value equals three, and the router 104e (referred to as “Router #5”) transmits a route request message 304 when the network reference value equals five. The routers 104c and 104e also generate link maps 306.

Routers 104a and 104e receive the route request message 304 from router 104c. Routers 104a-104c receive the route request message 304 from router 104e. Routers 104a, 104c, 104e need not perform any additional actions since they have already generated their link maps 306. Router 104b receives the route request message 304 from the router 104e. Router 104b synchronizes with the time slots 202 and the network reference value using the received message 304. Router 104b (referred to as “Router #2”) transmits a route request message 304 when the network reference value equals two. Router 104b also generates a link map 306, which indicates that only router 104e is visible to router 104b.

At the end of sequence 602d, all of the routers 104a-104e have received a link request message 302 or route request message 304 and generated a link map 306. All of the communication links between the routers 104a-104e in the mesh network 100 have been identified. However, the routers 104a-104e may wait for one more sequence 602e (having four time slots 202) to complete before the link discovery process 600 ends. While in this example the five routers 104a-104e were contacted within four sequences 602a-602d, the routers 104a-104e could have been arranged linearly, which would require five sequences before all routers 104a-104e were contacted.

As shown in FIG. 6, the maximum amount of time needed to complete the link discovery process 600 is denoted as “TimeLDP”. In some embodiments, the maximum time needed for the link discovery process 600 may be calculated by the central controller 102 as:
Time_{LDP}=HOPS²−HOPS+2 (1)
where HOPS represents the hops value 414 (which remains constant during the link discovery process 600). In this example, the hops value 414 equals five, and Time_{LDP} equals 22 (and the number of time slots 202 in FIG. 6 equals 22). While in this example all of the routers 104a-104e have received messages 302, 304 by the fourth sequence 602d, the worst case arrangement of the routers 104a-104e would require all 22 time slots 202. As a result, the central controller 102 may determine when the link discovery process 600 would end, no matter how the routers involved in the link discovery process 600 are arranged.

Although FIG. 6 illustrates one example of a link discovery process 600 for collecting routing information in a mesh network, various changes may be made to FIG. 6. For example, the timing of the various messages 304 shown in FIG. 6 is based on the layout of the routers 104a-104e in FIG. 1. The timing of the messages 304 shown in FIG. 6 would vary if the layout of the routers 104a-104e changes.

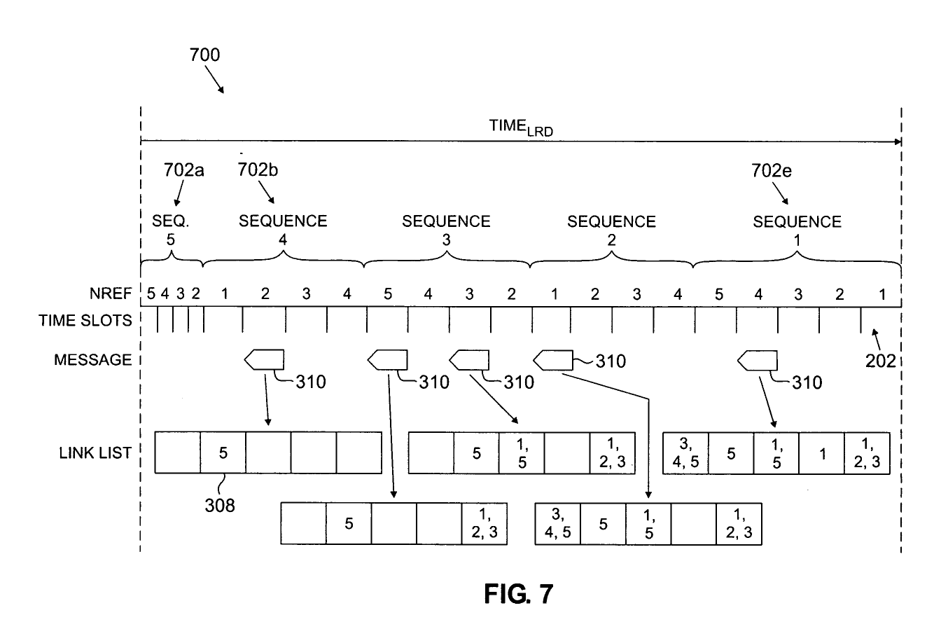

FIG. 7 illustrates an example link reporting process 700 for reporting collected routing information in a mesh network according to one embodiment of this disclosure. In particular, FIG. 7 illustrates how the messages 310 shown in FIG. 5 are used to report collected routing information to the central controller 102 in the mesh network 100. The link reporting process 700 shown in FIG. 7 is for illustration only. Other embodiments of the mesh network 100 that operate using different link reporting processes may be used without departing from the scope of this disclosure.

In this example, the link reporting process 700 includes additional sequences 702a-702e in which the network reference value is incremented and decremented. Each of the routers 104a-104e transmits a link response message 310 containing a link list 308. As with the link reporting process 600, each of the routers 104a-104e transmits its link response message 310 only when the network reference value equals a unique identifier associated with that router. Also, the sequences 702a-702e and the timing of the messages 310 shown in FIG. 7 represent the reverse timing shown in FIG. 6.

As shown in FIG. 7, the first router to transmit its link response message 310 is router 104b (referred to as “Router #2”), and the link response message 310 is transmitted when the network reference value equals two. The link response message 310 from router 104b contains a link list 308 where one entry (the second entry corresponding to router 104b) contains the routing information collected by the router 104b.

The only router to receive the link response message 310 from the router 104b is router 104e. The router 104e generates a link response message 310 containing a link list 308, where the link list 308 contains the routing information collected by the router 104b and router 104e. The router 104e (referred to as “Router #5”) then transmits its link response message 310 when the network reference value equals five.

Routers 104a-104c receive the link response message 310 from the router 104e. The router 104b need not perform any additional functions because it has already transmitted its link response message 310. Also, each of the routers 104a and 104c generates its own link response message 310 having a link list 308. Each of the routers 104a and 104c inserts the information from its own link map 306 into the link list 308 and the routing information contained in the link response message 310 from router 104e. Router 104c (referred to as “Router #3”) transmits its link response message 310 when the network reference value equals three.

Routers 104a and 104e receive the link response message 310 from router 104c. Router 104e need not perform any actions since it has already transmitted its link response message 310. Router 104a has previously generated its own link response message 310. Router 104a then consolidates any new information in the link response message 310 from the router 104c into its own link response message 310. Router 104a (referred to as “Router #1”) then transmits its link response message 310 when the network reference value equals one.

Routers 104c-104e receive the link response message 310 from the router 104a. Routers 104c and 104e need not perform any actions since they have already transmitted their link response messages 310. Router 104d generates its link response message 310, inserts the information from its link map 306 into the link list 308 in its own message 310, and inserts the information from the received message 310 into the link list 308 in its own message 308. Router 104d (referred to as “Router #4”) then transmits its link response message 310 when the network reference value equals four.

At this point, the central controller 102 receives the link response message 310 from the router 104d. This link response message 310 contains routing information from all routers 104a-104e that participated in the link discovery process 600 and the link reporting process 700. The link list 308 in this link response message 310 identifies all communication links between the routers 104a-104e. The central controller 102 may then use this information in any suitable manner, such as by using the information to route information to the user endpoints 106a-106d.

As shown in FIG. 7, the maximum amount of time needed to complete the link reporting process 700 is denoted as “Time_{LRP}”. In some embodiments, the maximum time needed for the link reporting process 700 may be calculated by the central controller 102 as:
Time_{LRP}=HOPS²−HOPS+1 (2)
In this example, the hops value 414 equals five, and Time_{LRP} equals 21 (and the number of time slots 202 in FIG. 7 equals 21). As with FIG. 6, all of the routers 104a-104e have transmitted their link response messages 310 within four sequences 702b-702e, the worst case arrangement of the routers 104a-104e would require all 21 time slots 202. As a result, the central controller 102 may determine when the link reporting process 700 would end, no matter how the routers involved in the link reporting process 700 are arranged.

Although FIG. 7 illustrates one example of a link reporting process 700 for reporting collected routing information in a mesh network, various changes may be made to FIG. 7. For example, the timing of the various messages 310 shown in FIG. 7 is based on the layout of the routers 104a-104e in FIG. 1. The timing of the messages 310 shown in FIG. 7 would vary if the layout of the routers 104a-104e changes.

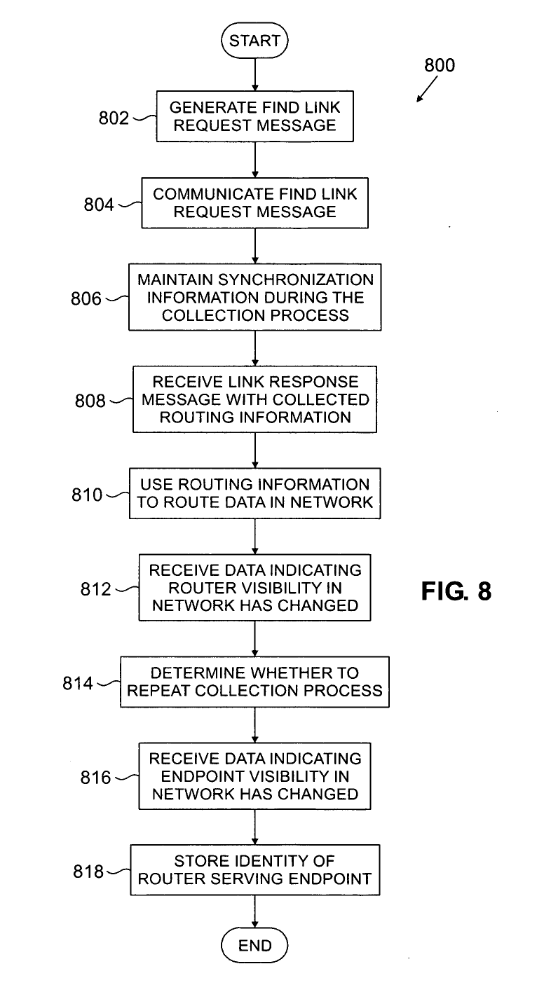

FIG. 8 illustrates an example method 800 for collecting routing information in a mesh network at a central controller according to one embodiment of this disclosure. For ease of explanation, the method 800 is described with respect to the central controller 102 operating in the mesh network 100 of FIG. 1. The method 800 could be used by any other device and in any other system without departing from the scope of this disclosure.

The central controller 102 generates a find link request message at step 802. This may include, for example, the central controller 102 generating a find link request message 302 as shown in FIG. 4.

The central controller 102 communicates the find link request message at step 804. This may include, for example, the central controller 102 broadcasting the find link request message 310 to any of the routers 104a-104e within range of the central controller 102.

The central controller 102 maintains synchronization information during the collection process at step 806. This may include, for example, the central controller 102 identifying the time slots 202, incrementing and decrementing the hops value 414, 514 when appropriate, and incrementing and decrementing the sequence value 416, 516 when appropriate.

The central controller 102 receives a link response message containing the collected routing information at step 808. This may include, for example, the central controller receiving a link response message 310 containing a link list 308, where the link 308 contains routing information collected by multiple routers. In particular embodiments, the link list 308 contains routing information collected by all of the routers 104a-104e in the mesh network 100.

The central controller 102 uses the collected routing information to route data in the mesh network at step 810. This may include, for example, the central controller 102 using the information to route data to particular user endpoints 106a-106d. At this point, the link discovery process and the link reporting process have completed.

The central controller 102 receives data indicating that router visibility has changed in the mesh network at step 812. This may include, for example, the central controller 102 receiving one or more messages indicating that one or more routers 104a-104e have set their link discovery update flag. The link discovery update flag indicates that the associated router has identified at least one other router that is visible and that was not visible during the prior collection process.

The central controller 102 determines whether to repeat the collection process at step 814. This may include, for example, the central controller 102 identifying the routers 104a-104e that have reported new visibility in the mesh network 100. This may also include the central controller 102 comparing the number of routers 104a-104e reporting new visibility to a threshold value. The central controller 102 may use any other suitable technique or criteria to determine when to repeat the collection process. If the collection process is to be repeated, the central controller 102 may repeat the method 800.

The central controller 102 receives data indicating that endpoint visibility has changed in the mesh network at step 816. This may include, for example, the central controller 102 receiving one or more messages indicating that one or more routers 104a-104e have detected new user endpoints that are visible to those router(s). The central controller 102 stores the identity of the router serving a new endpoint at step 818. This may include, for example, the central controller 102 storing the unique identifier of the router serving a new endpoint.

Although FIG. 8 illustrates one example of a method 800 for collecting routing information in a mesh network at a central controller, various changes may be made to FIG. 8. For example, the central controller 102 could communicate with two or more separate groups of routers, where there is no interconnection between the routers. In this case, the central controller 102 may receive a link response message 310 from each group of routers.

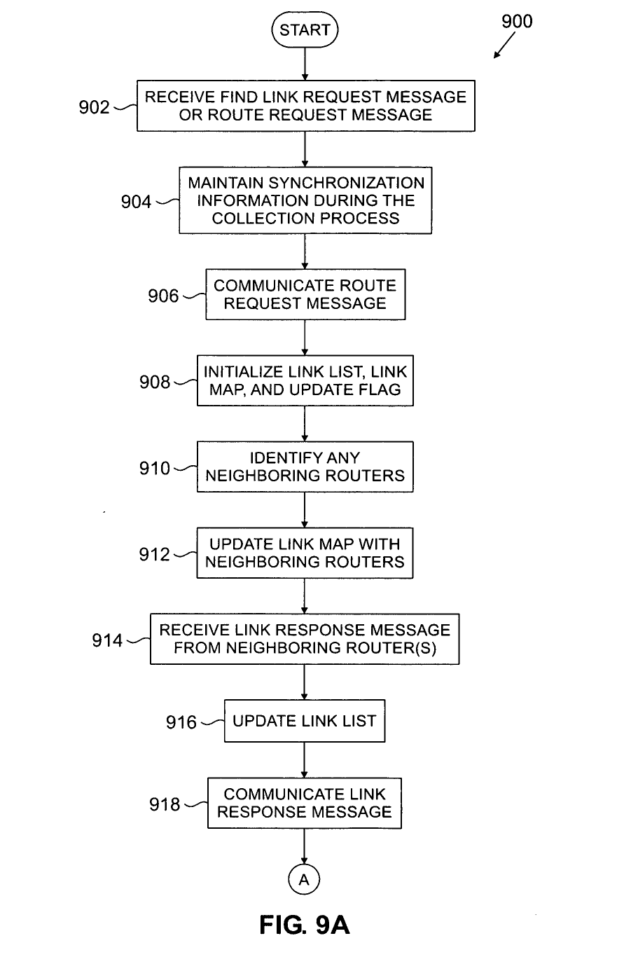

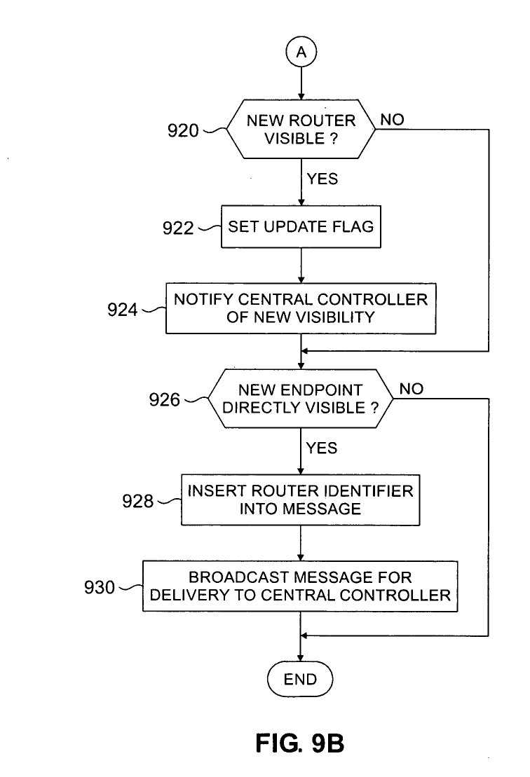

FIGS. 9A and 9B illustrate an example method 900 for collecting and reporting routing information at a router in a mesh network according to one embodiment of this disclosure. For ease of explanation, the method 900 is described with respect to one of the routers 104a-104e operating in the mesh network 100 of FIG. 1. The method 900 could be used by any other device and in any other system without departing from the scope of this disclosure.

A router receives a find link request message or a route request message at step 902. This may include, for example, the router 104d receiving a find link request message 302 from the central controller 102. This may also include the router 104a receiving a route request message 304 from the router 104d.

The router maintains synchronization information during the collection process at step 904. This may include, for example, the router using the received message 302, 304 to identify the time slots 202. This may also include the router incrementing and decrementing the hops value 414, 514 when appropriate and incrementing and decrementing the sequence value 416, 516 when appropriate.

The router communicates a route request message at step 906. This may include, for example, the router broadcasting the route request message 304 to any router within range.

The router initializes a link map, a link list, and an update flag at step 908. This may include, for example, the router initializing a link map 306 to identify no routers and a link list 308 having a number of entries equal to the hops value contained in the received message 302, 304. This may also include the router initializing a negative value for the link discovery update flag.

The router identifies any neighboring routers at step 910. This may include, for example, the router monitoring a frequency or frequencies used by the routers 104a-104e. This may also include the router determining if any signals identifying a neighboring router are received.

The router updates its link map with the identity of any identified neighboring routers at step 912. This may include, for example, placing unique identifiers associated with the identified neighboring routers in the link map 306.

The router receives a link response message from one or more of the neighboring routers at step 914. This may include, for example, the router receiving a link response message 310 containing a link list 308. The link list 308 contains routing information collected by one or more other routers in the mesh network 100.

The router updates its link list at step 916. This may include, for example, the router inserting information from the router's link map 306 into the router's link list 308. This may also include the router placing information from a link list 308 in the received link response message 310 into the router's link list 308.

The router communicates a link response message at step 918. This may include, for example, the router broadcasting a link response message 310 containing the router's link list 308. The link list 308 in this message 310 contains information from the router's link map 306 and from the received message 310. At this point, the link discovery process and the link reporting process have completed in the router.

The router determines whether a new router is visible at step 920. This may include, for example, the router receiving a message broadcast from the new router and determining that the new router was not visible during the link discovery process and the link reporting process. The new router may represent a router new to the mesh network 100 or a router that was already in the mesh network 100 but not visible earlier.

If a new router is visible, the router sets an update flag at step 922. This may include, for example, the router setting its link discovery update flag to an affirmative value. This indicates that at least one new router has become visible to the router since the last collection process. The router also notifies the central controller 102 of the new visibility at step 924. This may include, for example, the router embedding an indication that its update flag has been set in one, some, or all messages routed through that router to the central controller 102.

The router also determines whether a new user endpoint is directly visible at step 926. This may include, for example, the router receiving a message and determining that the message was broadcast by a new user endpoint. The new user endpoint may represent a user endpoint new to the mesh network 100 or a user endpoint that was already in the mesh network 100 but not visible earlier.

If a new user endpoint is detected, the router inserts its identifier into the message at step 928. This may include, for example, the router embedding a unique identifier associated with that router in the message. This may also include the router embedding into the message an indication that the user endpoint is newly visible to the router.

The router broadcasts the message for delivery to the central controller 102 at step 930. This may include, for example, the router broadcasting the message containing the embedded information directly to the central controller 102 or indirectly to the central controller 102 through one or more other routers.

Although FIGS. 9A and 9B illustrate one example of a method 900 for collecting and reporting routing information at a router in a mesh network, various changes may be made to FIGS. 9A and 9B. For example, the router may not receive a link response message from a neighboring router at step 914, and the router would update its link list 308 at step 916 only by placing the information from its link map 306 in the link list 308.

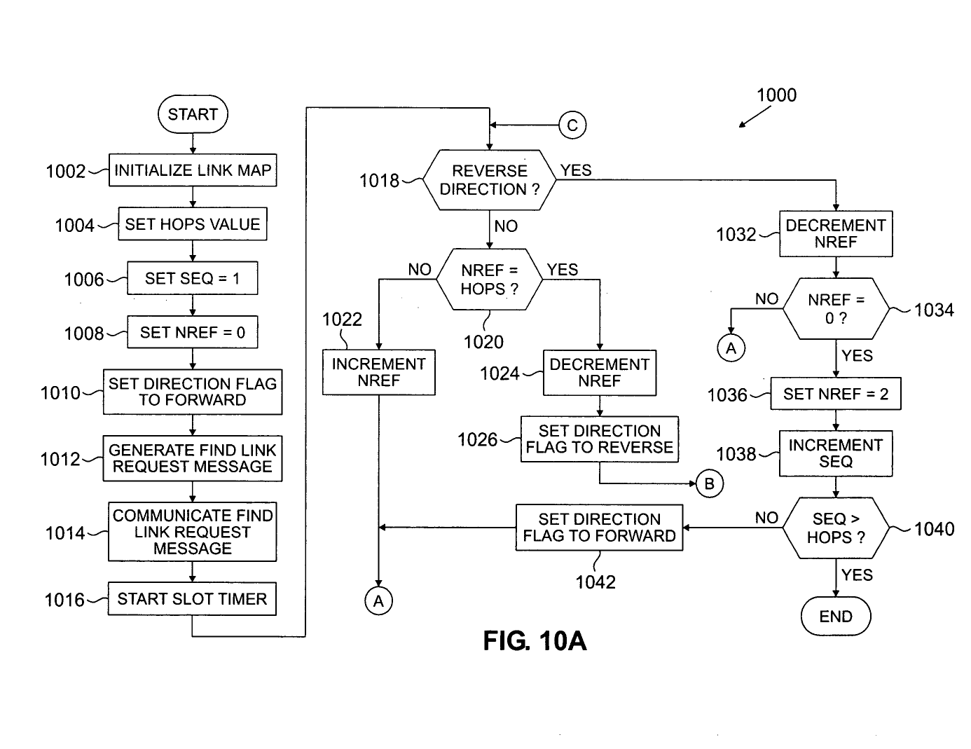

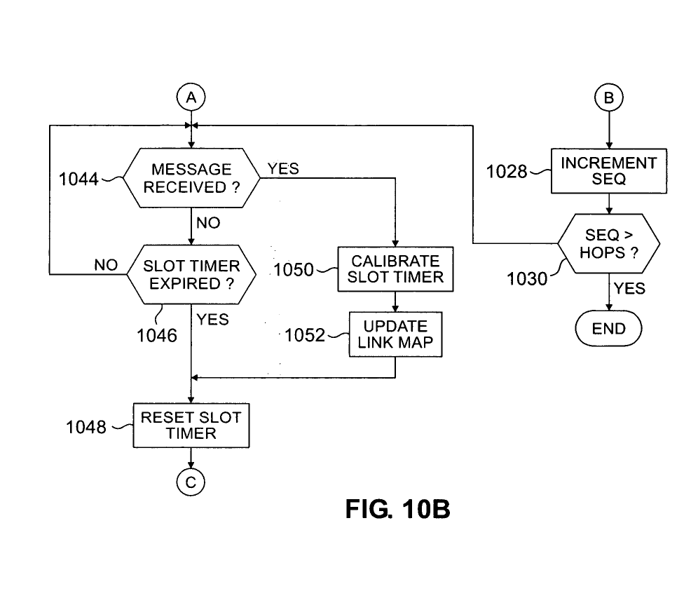

FIGS. 10A and 10B illustrate another example method 1000 for collecting routing information at a central controller in a mesh network according to one embodiment of this disclosure. For ease of explanation, the method 1000 is described with respect to the central controller 102 operating in the mesh network 100 of FIG. 1. The method 1000 could be used by any other device and in any other system without departing from the scope of this disclosure.

The central controller 102 initializes a link map 306 at step 1002. In this example, the central controller 102 may maintain a link map 306 identifying all of the routers that are visible to the central controller 102. This allows the central controller 102 to identify which of the routers 104a-104e are directly accessible to the central controller 102 and which of the routers 104a-104e are indirectly accessible through other routers.

The central controller 102 initializes a hops value at step 1004. This may include, for example, the central controller 102 setting the hops value 414 to a value identifying the number of routers to participate in the link discovery process.

The central controller 102 also initializes a sequence value at step 1006 and a network reference value at step 1008. This may include, for example, the central controller setting the sequence value 416 to a value of one and the network reference value 418 to a value of zero. In addition, the central controller 102 initializes a direction flag at step 1010. This may include, for example, the central controller setting the direction flag to the forward direction. The direction flag indicates whether the network reference value 418 is incremented or decremented.

The central controller 102 generates a link request message at step 1012. This may include, for example, the central controller using the values 414-418 initialized above to generate the find link request message 302. The central controller 102 communicates the find link request message at step 1014.

The central controller 102 starts a slot timer at step 1016. The slot timer is set to a value equal to a message length 206 of the find link request message 302 plus a known length of additional time 208. The slot timer allows the central controller 102 to identify the time slots during the collection process.

The central controller 102 determines whether the direction flag is set to the reverse direction at step 1018. If so, the central controller 102 determines if the current network reference value equals the hops value at step 1020. If not, the network reference value 418 is being incremented and has not yet reached a maximum value (the hops value 414), and the network reference value 418 is incremented at step 1022. Otherwise, the network reference value 418 is being incremented and has reached the maximum value, and a sequence (such as one of sequences 602a-602e) has concluded. The network reference value is therefore decremented at step 1024, and the direction flag is set to a reverse direction at step 1026, and the sequence value is incremented at step 1028.

The central controller 102 determines if the sequence value exceeds the hops value at step 1030. If not, the link discovery process has not concluded. Otherwise, if the sequence value exceeds the hops value, the link discovery process has concluded, and the method 1000 ends.

If the direction flag is set to the reverse direction at step 1018, the central controller 102 decrements the network reference value at step 1032. The central controller 102 determines if the network reference value equals zero at step 1034.

If not, the network reference value is being decremented and reached a minimum value. If the network reference value equals zero, the minimum value has been passed, so the network reference value is set to a value of two at step 1036. The sequence value is then incremented at step 1038.

The central controller 102 determines if the sequence value exceeds the hops value at step 1040. If not, the link discovery process has not concluded, and the central controller 102 sets to direction flag to the forward direction at step 1042. Otherwise, if the sequence value exceeds the hops value, the link discovery process has concluded. The central controller 102 may then wait to receive a link response message 310 containing a consolidated link list 308. The consolidated link list 308 contains information from multiple routers identifying the communication paths between the routers. The consolidated link list 308 may contain information from all of the routers 104a-104e identifying the communication paths between the routers.

After steps 1022, 1030, or 1042, the central controller 102 determines if any message is received from a neighboring router at step 1044. If not, the central controller 102 determines whether the current time slot has expired at step 1046. This may include, for example, the central controller 102 using the slot timer to determine if the current time slot 202 has expired. If not, the central controller 102 returns to step 1044.

If the current time slot has expired, the central controller 102 resets the slot timer at step 1048. This initiates a new time slot 202, and the central controller 102 returns to step 1018 to increment to decrement the network reference value.

If a message is received at step 1044, the central controller 102 calibrates its slot timer at step 1050. This may include, for example, the central controller 102 adjusting the time slots 202 as shown in FIG. 2 so that the time slots 202 are synchronized with the new message. The central controller 102 then updates its link map at step 1052. This may include, for example, the central controller 102 identifying the router that broadcast the received message and inserting the router's unique identifier into the link map 306 of the central controller 102. In this way, the central controller 102 identifies the routers that are visible to the central controller 102 and updates its link map 306 accordingly. The central controller 102 then returns to step 1018.

Although FIGS. 10A and 10B illustrate another example of a method 1000 for collecting routing information at a central controller in a mesh network, various changes may be made to FIGS. 10A and 10B. For example, FIGS. 10A and 10B illustrate one technique for maintaining synchronization in the mesh network 100 using various values and flags. Other synchronization techniques could also be used in the mesh network 100.

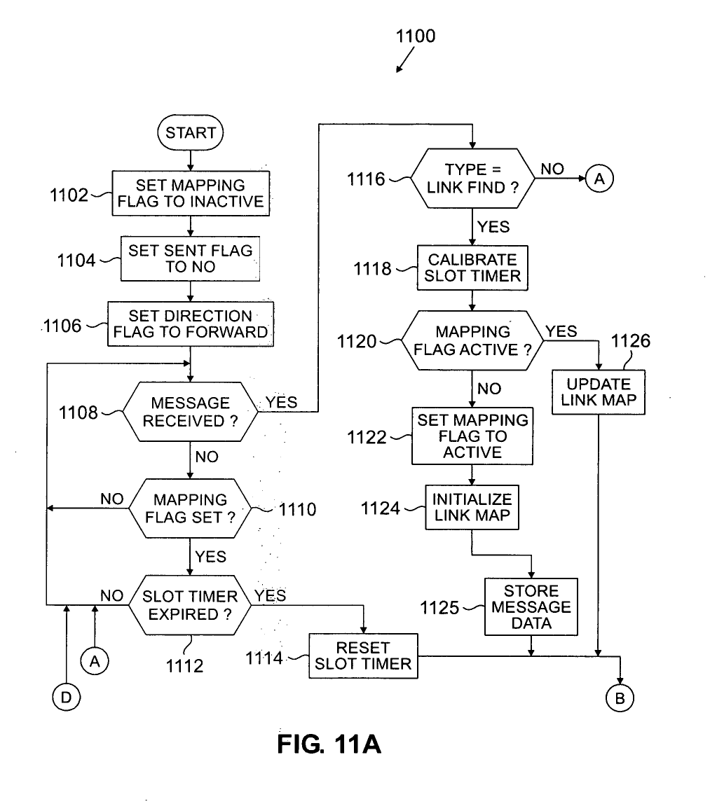

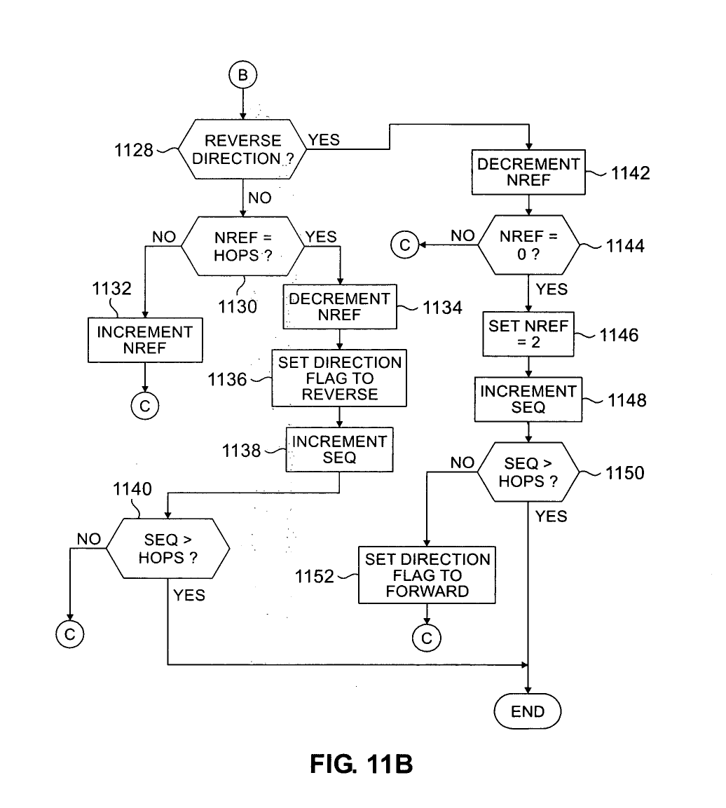

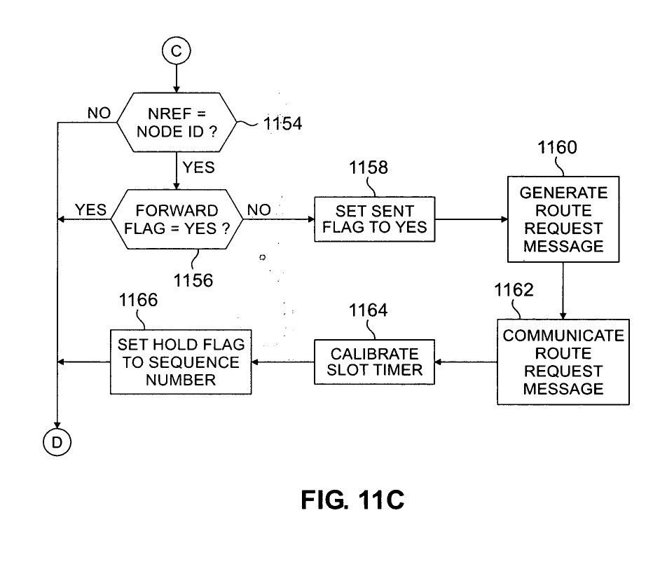

FIGS. 11A through 11C illustrate an example method 1100 for collecting routing information at a router in a mesh network according to one embodiment of this disclosure. In particular, FIGS. 11A through 11C illustrate an example method 1100 for collecting routing information during the link discovery process. For ease of explanation, the method 1100 is described with respect to one of the routers 104a-104e operating in the mesh network 100 of FIG. 1. The method 1100 could be used by any other device and in any other system without departing from the scope of this disclosure.

The router initializes a mapping flag to an inactive value at step 1102. The mapping flag is used by the router to indicate whether the router is currently participating in a link discovery process and link reporting process. The router initializes a sent flag to a negative value at step 1104. The sent flag indicates whether the router has already forwarded a route request message 304 during the collection process. The router initializes a direction flag to forward at step 1106. The direction flag indicates whether the network reference value is incremented or decremented.

The router determines if a message is received at step 1108. The message may, for example, represent a find link request message 302, a route request message 304, or a message unrelated to the collection process. If no message is received, the router determines whether it is currently engaged in a collection process using the mapping flag at step 1110. If not, the router returns to step 1108. If so, the router takes actions to maintain its synchronization with the time slots 202 during the collection process. In particular, the router determines if its slot timer has expired at step 1112. The router then returns to step 1108 if the slot timer has not expired or resets the slot timer at step 1114 if it has expired.

If a message was received at step 1108, the router determines if the message type indicates that the message is a “find link” type of message at step 1116. This may include, for example, the router determining if the message type indicates that the message is a find link request message 302 or a route request message 304. If not, the router returns to step 1108.

If the message is a “find link” type of message, the router calibrates its slot timer at step 1118. This may include, for example, the router adjusting the time slots 202 as shown in FIG. 2 so that the time slots 202 are synchronized with the new message.

The router determines whether the mapping flag is currently set to active at step 1120. As described above with respect to FIG. 6, a router may receive multiple route request messages 304 during the link discovery process, such as when router 104a receives a first route request message 304 from router 104d, a second route request message 304 from router 104c, and a third route request message 304 from router 104e. The mapping flag allows the router to determine if it is receiving a new request to collect routing information or a repeated request.

If the mapping flag is not set, the router sets the mapping flag to active at step 1122 and initializes a link map at step 1124. This may include, for example, the router creating a new link map 306. The router may also insert the identity of the component broadcasting the message (the message received at step 1108) into the link map 306. This indicates that the component broadcasting the message is visible to this router. The router stores information about the received message at step 1125. This may include, for example, the router storing the hops value 414, the sequence value 416, and the network reference value 418 of the message for use later during the link reporting process.

If the mapping flag is already active, the router updates its link map at step 1126. In this case, the router has already started collecting information about other visible routers, and the identity of the component broadcasting the message is placed into the link map 306.

At this point, the router performs steps 1128-1152. These steps 1128-1152 implement various functions required to maintain synchronization, such as maintaining an accurate network reference value so that the router transmits only in appropriate time slots 202.

Once these steps 1128-1152 are completed, the router determines if the network reference value equals the router's unique identifier at step 1154. If not, the router returns to step 1108 to await another message. Otherwise, the current time slot 202 represents a time slot belonging to the router.

The router uses the sent flag to determine whether it has broadcast a route request message 304 during the collection process at step 1156. If so, the router does not need to broadcast the message again, and the router returns to step 1108. Otherwise, the router sets the sent flag to an affirmative value at step 1158 and generates a route request message at step 1160. This may include, for example, the router generating a route request message 304 identifying the router as the source of the message. The router communicates the route request message at step 1162 and calibrates its slot timer to correspond to the time slots 202 as defined by the route request message at step 1164. The router sets a hold flag to the current sequence value at step 1166. The hold flag identifies the sequence value of the sequence during which the router transmitted the route request message 304. This value is used to ensure that the router transmits a link response message 310 during the corresponding sequence of the link reporting process. The router then returns to step 1108.

If each of the routers participating in the link discovery process performs these functions, each router transmits a single route request message 304 during the link discovery process. Also, each router maintains synchronization with the other components in the mesh network 100, and each router collects information identifying communication paths to and from that router.

Although FIGS. 11A through 11C illustrate one example of a method 1100 for collecting routing information at a router in a mesh network, various changes may be made to FIGS. 11A through 11C. For example, FIGS. 11A through 11C illustrate one technique for maintaining synchronization in the mesh network 100 using various values and flags. Other synchronization techniques could also be used in the mesh network 100.

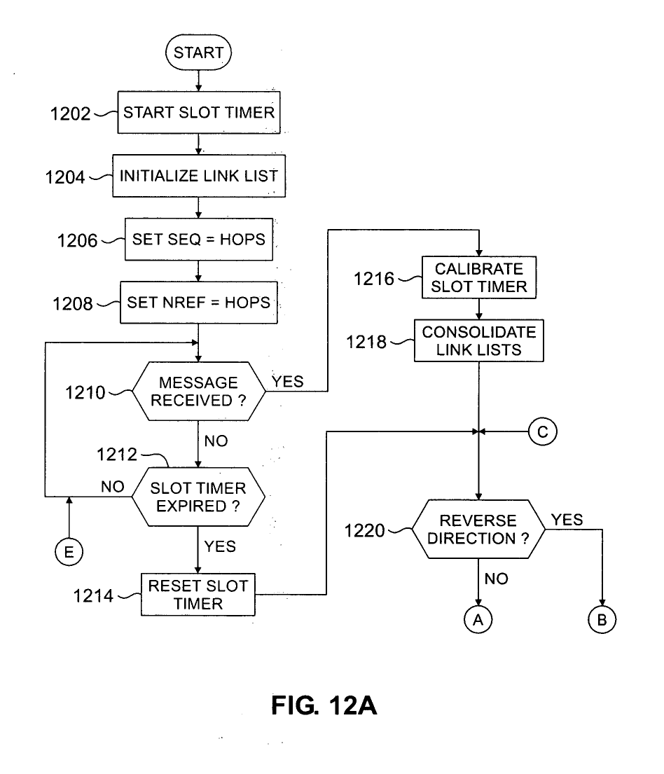

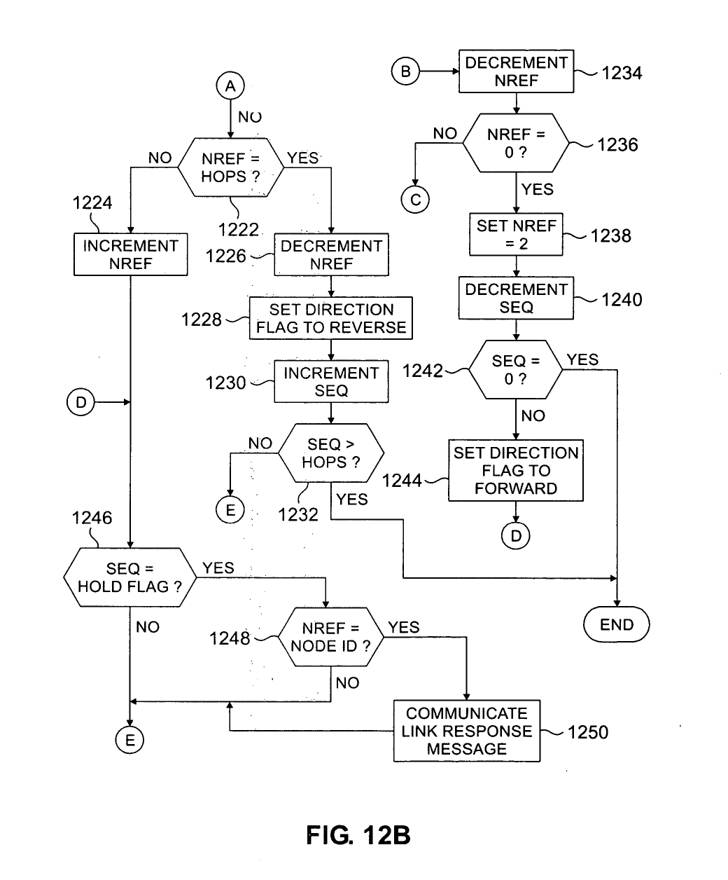

FIGS. 12A and 12B illustrate an example method 1200 for reporting collected routing information in a mesh network according to one embodiment of this disclosure. In particular, FIGS. 12A and 12B illustrate an example method 1200 for reporting collected routing information during the link reporting process. For ease of explanation, the method 1200 is described with respect to one of the routers 104a-104e operating in the mesh network 100 of FIG. 1. The method 1200 could be used by any other device and in any other system without departing from the scope of this disclosure.

The router starts a slot timer at step 1202. The method 1200 may be performed at the end of method 1100 in FIGS. 11A through 11C, and the slot timer may be set to a value that was used by the router at the end of method 1100.

The router initializes a link list at step 1204. This may include, for example, the router creating a new link list 308. This may also include the router inserting information from the router's link map 306 into the appropriate entry in the link list 308. The router initializes the sequence value at step 1206 and the network reference value at step 1208. This may include, for example, the router setting the sequence value 516 and the network reference value 518 to the hops value 514.

The router determines if a message is received at step 1210 and if the slot timer has expired at step 1212. If no message is received and the slot timer has not expired, the router returns to step 1210 to await a message. If the slot timer has expired, the router resets the slot timer at step 1214.

If a message is received at step 1210, the router calibrates its slot timer at step 1216. This may include, for example, the router adjusting the time slots 202 as shown in FIG. 2 so that the time slots 202 are synchronized with the new message.

The router consolidates link lists at step 1218. This may include, for example, the router extracting a link list 308 from the link response message 310 received during step 1210. This may also include the router combining the information in that link list 308 with the router's link list 308.

After step 1214 or 1218, the router performs steps 1220-1244. These steps maintain synchronization in the router during the link reporting process. Also, the router at step 1242 determines whether the sequence value equals zero. If so, the link reporting process has completed, and the method 1200 ends.

After steps 1220-1244, the router determines if the current sequence value equals the value stored in the hold flag at step 1246. If not, the router is not allowed to transmit a link response message 310 during the sequence, and the router returns to step 1210. If the current sequence value equals the value stored in the hold flag, the router determines if the current network reference value equals the router's unique identifier at step 1248. If not, the router is not allowed to transmit in the current time slot 202, and the router returns to step 1210. If the current network reference value equals the router's unique identifier, the router transmits a link response message at step 1250. This may include, for example, the router transmitting a link response message 310 containing the consolidated link list 308 produced at step 1218.

The method 1200 shown in FIGS. 12A and 12B has been described as being performed by the routers during the link reporting process. A similar method could be used by the central controller 102 during the link reporting process. For example, the central controller 102 could perform steps 1202-1244 of the method 1200 and skip steps 1246-1250. Using steps 1202-1244 would allow the central controller 102 to maintain synchronization during the link reporting process and to receive one or multiple link lists 308 from one or more routers (depending on the layout of the mesh network), where the link lists 308 contain collected routing information.

Although FIGS. 12A and 12B illustrate one example of a method 1200 for reporting collected routing information in a mesh network, various changes may be made to FIGS. 12A and 12B. For example, FIGS. 12A and 12B illustrate one technique for maintaining synchronization in the mesh network 100 using various values and flags. Other synchronization techniques could also be used in the mesh network 100.

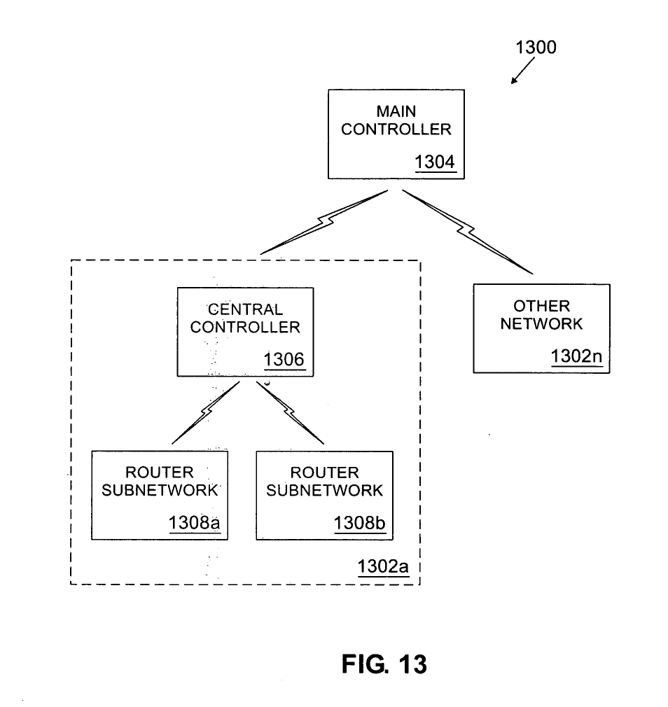

FIG. 13 illustrates an example multi-network mesh network configuration 1300 according to one embodiment of this disclosure. The embodiment of the multi-network mesh network configuration 1300 shown in FIG. 13 is for illustration only. Other embodiments of the mesh network may be used without departing from the scope of this disclosure.

In this example, the multi-network mesh network configuration 1300 includes multiple mesh networks 1302a-1302n and a main controller 1304. One of the mesh networks 1302a in FIG. 13 includes a central controller 1306 and multiple router subnetworks 1308a-1308n.

Each of the router subnetworks 1308a-1308n includes one or more routers, such as the routers 104a-104e of FIG. 1. Communications between routers in the subnetworks 1308a-1308n may occur directly between the routers or indirectly through the central controller 1306. In some embodiments, the routers in each of the subnetworks 1308a-1308n may communicate using a unique radio frequency or frequencies, and there is no contention between the subnetworks 1308a-1308n. In other embodiments, the routers in the subnetworks 1308a-1308n communicate using the same radio frequency or frequencies, and the central controller 1306 synchronizes the routers to reduce or avoid collisions. In still other embodiments, the central controller 1306 may communicate with the routers using one frequency or set of frequencies, and the routers in each of the subnetworks 1308a-1308n communicate using a different frequency or set of frequencies.

As shown in FIG. 13, the main controller 1304 communicates with each of the mesh networks 1302a-1302n. The main controller 1304 may perform any of a wide variety of functions. For example, the main controller 1304 could log information collected by the mesh networks 1302a-1302n. The main controller 1304 could also control the operations of the mesh networks 1302a-1302n. As an example, the main controller 1304 could ensure that the mesh networks 1302a-1302n do not interfere with one another and reduce or eliminate collisions between the mesh networks 1302a-1302n.

As a specific example, the main controller 1304 could poll the various mesh networks 1302a-1302n and determine which mesh networks have the most traffic. The main controller 1304 could then allow the mesh networks with the most traffic to transmit data and place the remaining mesh networks into an idle state. As another specific example, the main controller 1304 could place each of the mesh networks into an idle state or an active state at specified intervals, allowing each of the mesh networks to transmit data only when active. As yet another specific example, the main controller 1304 could split a transmission time into sub-bands (such as 100 ms sub-bands) and assign a sub-band to each mesh network, where each mesh network may only transmit data during its sub-band.

The central controllers 1306 in the mesh networks 1302a-1302n may also cooperate to reduce contention between the mesh networks 1302a-1302n. For example, the central controllers 1306 could each detect when another central controller 1306 is operating on the same frequency. The central controllers 1306 may then operate as normal until one or more of them detect collisions. After that, the central controllers 1306 may synchronize their routers to help avoid collisions. The central controllers 1306 could also determine when their mesh networks 1302a-1302n are about to go idle and inform the other central controllers 1306, allowing the other central controllers 1306 to utilize the idle network's transmission times.

The multi-network mesh network configuration 1300 shown in FIG. 13 could implement any suitable functionality. For example, the multi-network mesh network configuration 1300 could represent a security/monitoring system where each of the mesh networks 1302a-1302n collects security information in a different building. Also, each of the router subnetworks 1308a-1308n could collect security information on a different floor of a building. The security information could represent any type of information, such as information identifying doors that open, rooms light that are activated, and air conditioner settings. Each central controller 1306 could timestamp and log information identifying these different events and make that information available of the main controller 1304.

Although FIG. 13 illustrates one example of a multi-network mesh network configuration 1300, various changes may be made to FIG. 13. For example, the mesh network configuration 1300 could include any number of mesh networks 1302a-1302n. Also, each mesh network could include any number of router subnetworks 1308a-1308n.

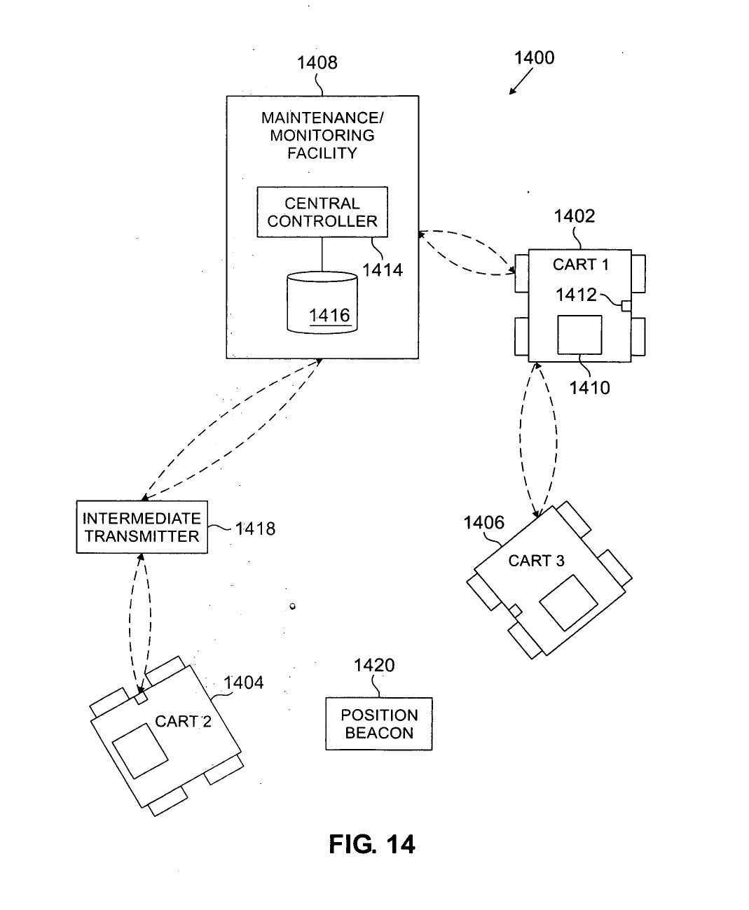

FIGS. 14 through 19 illustrate one possible example of a specific implementation of the mesh network described above. In this example, a mesh network is implemented in an environment where vehicles are monitored. As a particular example, the mesh network may be implemented at a golf course to monitor the operations of multiple golf carts. In these embodiments, at least some of the monitored vehicles may each include or represent a combination of a router 104 and an endpoint 106 shown in FIG. 1. In other words, the monitored vehicles may have the ability to transmit and receive data to and from a central controller or each other. Each of the monitored vehicles may also have the ability to receive incoming communications (such as messages from other vehicles or a central controller) and broadcast the communications for receipt by other vehicles or a central controller. In this way, one or more of the monitored vehicles could represent a mobile router in a mesh network. This represents one possible environment where the mesh network functionality could be implemented. The mesh network functionality could be used in any other suitable environment without departing from the scope of this disclosure. Also, while the following description may describe the monitoring of multiple vehicles using the mesh network described above, other types of communication networks could be used to facilitate monitoring of the vehicles.

FIG. 14 illustrates an example system 1400 for monitoring use of vehicles according to one embodiment of this disclosure. The system 1400 shown in FIG. 14 is for illustration only. Other embodiments of the system 1400 may be used without departing from the scope of this disclosure.

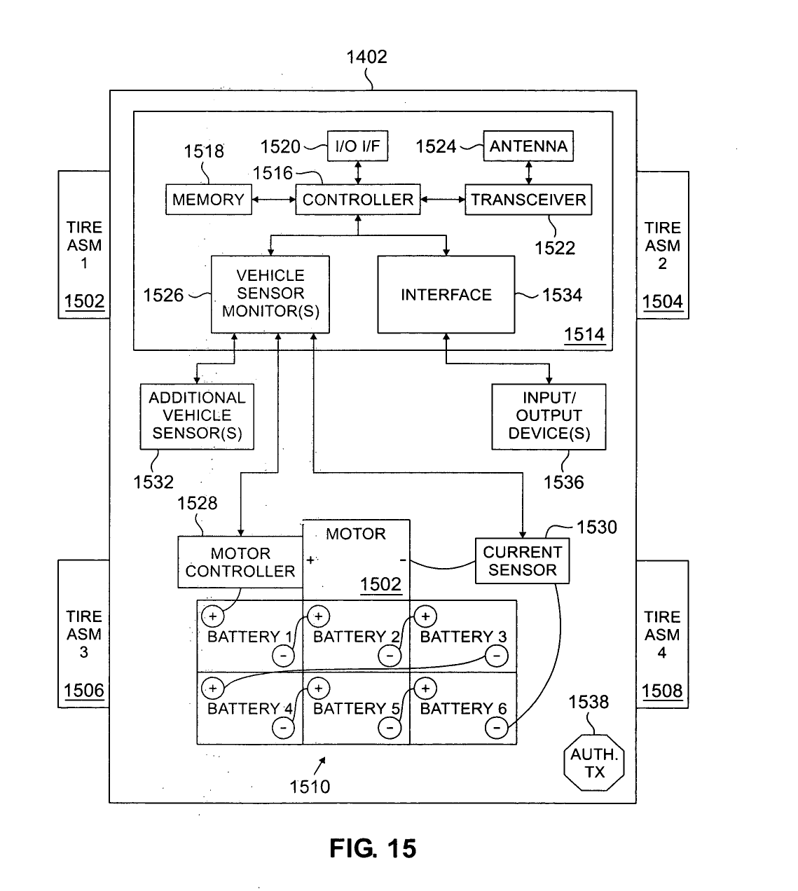

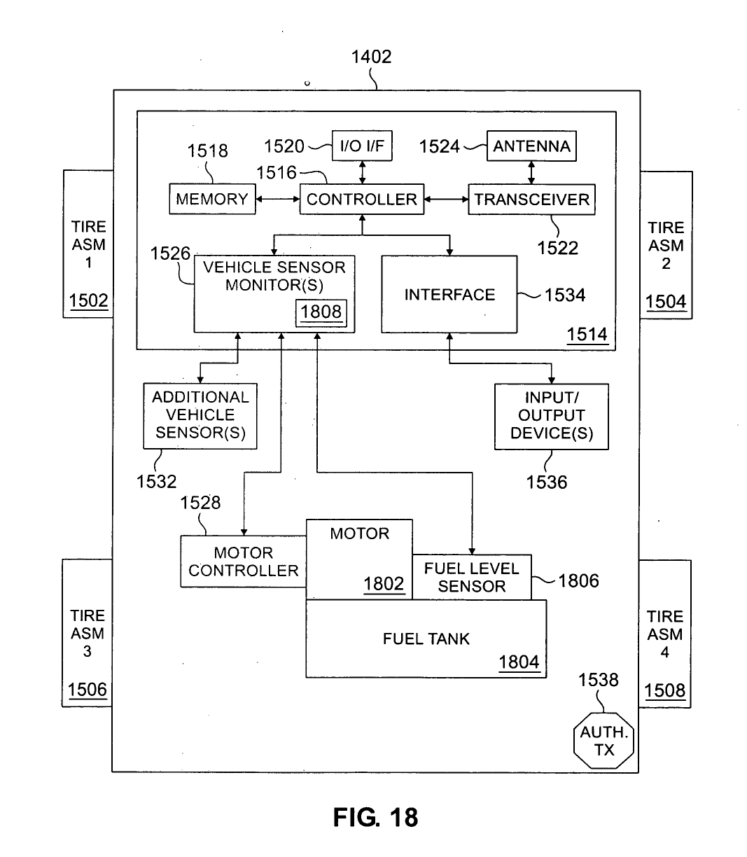

As shown in FIG. 14, the system 1400 includes one or more carts 1402-1406 and a maintenance/monitoring facility 1408. The carts 1402-1406 may represent transportation vehicles capable of transporting one or more people. The carts 1402-1406 could also be used to transport equipment or any other or additional cargo. The carts 1402-1406 may represent any suitable transportation vehicles. As a specific example, the carts 1402-1406 could represent golf carts used to transport one or more golfers and one or more golf bags containing clubs and other equipment used by the golfers. Example embodiments of the carts 1402-1406 are shown in FIGS. 15 and 18, which are described below.

The maintenance/monitoring facility 1408 represents any suitable facility responsible for monitoring the condition of the carts 1402-1406 and/or maintaining the carts 1402-1406. For example, the maintenance/monitoring facility 1408 could represent a facility where the carts 1402-1406 may be examined (such as by measuring tire pressure) and maintenance can be performed (such as by inflating tires and charging batteries). Other or additional forms of maintenance could be performed at the maintenance/monitoring facility 1408. Also, the maintenance/monitoring facility 1408 could monitor the conditions of the carts 1402-1406 without actually performing any maintenance.

In this example, each of the carts 1402-1406 includes a monitoring system 1410 and a transceiver 1412. Each monitoring system 1410 monitors one or more measurable characteristics of one of the carts 1402-1406. For example, the monitoring system 1410 could monitor the pressure in the various tires on the cart 1402. As another example, the monitoring system 1410 could monitor the power supply in the cart 1402, such as by measuring the battery power provided by one or more batteries or the fuel level in a fuel tank. As a further example, the monitoring system 1410 could monitor use of the cart 1402 to identify misuse, such as when the monitoring system 1410 detects that the cart 1402 is in use and that use has not been authorized. As an additional example, the monitoring system 1410 could monitor the use of the cart 1402 to detect abuse, such as by monitoring the acceleration, brake use, and inclination of the cart 1402. In this document, the term “misuse” refers to any unauthorized use of a cart, including use of the cart that was authorized and then exceeded the scope of the authorization. Also, the term “abuse” refers to any use of a cart that could or does cause injury or damage to occupants or cargo of the cart or to the cart itself.

The information collected by the monitoring system 1410 could be transmitted to a central controller or other processing center for analysis. The information collected by the monitoring system 1410 could also be analyzed by the monitoring system 1410, such as by comparing the tire pressure to a first threshold or the battery power to a second threshold. The monitoring system 1410 could then generate alerts if the tire pressure or battery power level falls below the thresholds. The monitoring system 1410 includes any hardware, software, firmware, or combination thereof for sensing and/or monitoring at least one characteristic of a vehicle.

The transceiver 1412 is capable of transmitting information collected and/or generated by the monitoring system 1410. For example, the transceiver 1412 could transmit the measured tire pressure and the measured battery power level to a central controller or other processing center. The transceiver 1412 could also transmit any alerts generated by the monitoring system 1410, such as an alert indicating that the battery power of the cart 1402 has fallen below a threshold. In some embodiments, the transceiver 1412 is further capable of receiving information from the central controller or other processing center. This allows, for example, a warning of inclement weather to be received by the monitoring system 1410 and presented to people using the carts 1402-1406. The transceiver 1412 includes any hardware, software, firmware, or combination thereof for transmitting information. The transceiver 1412 could, for example, represent a radio frequency (“RF”) transceiver. In particular embodiments, the transceiver 1412 could include the functionality of a router 104 shown in FIG. 1. In these embodiments, the transceiver 1412 in each of the carts 1402-1406 could route or repeat messages received from other carts or the central controller or other processing center. In other embodiments, the transceiver 1412 could be replaced with a transmitter capable of transmitting information but not receiving information.

In this example, the information transmitted by the carts 1402-1406 is received and processed at a central controller 1414 in the maintenance/monitoring facility 1408. The central controller 1414 may use the information from the carts 1402-1406 in any suitable manner. For example, the central controller 1414 could analyze the information and detect low tire pressures or low power supplies in the carts 1402-1406. The central controller 1414 could also identify misuse of the carts 1402-1406. This may include, for example, the central controller 1414 identifying when the carts 1402-1406 are in use without authorization. This may also include the central controller 1414 ensuring that the carts 1402-1406 are not being used for longer time periods than authorized or in areas where the carts 1402-1406 are not authorized. The central controller 1414 could further monitor how the carts 1402-1406 are being used and identify abuse, such as when the carts 1402-1406 are repeatedly accelerating when traveling at large inclinations. In addition, the central controller 1414 could initiate communications of alerts to appropriate personnel (such as fleet managers) and/or warnings to the carts 1402-1406 (such as warnings about inclement weather or detected misuse or abuse). The central controller 1414 includes any hardware, software, firmware, or combination thereof for analyzing information from the carts 1402-1406. As an example, the central controller 1414 could include an RF transceiver with an antenna, a microprocessor (such as in a personal computer or other computing device), a memory, a video screen, and software and/or firmware capable of performing necessary system functions.

The central controller 1414 is coupled to a database 1416. In this document, the term “couple” and its derivatives refer to any direct or indirect communication between two or more elements, whether or not those elements are in physical contact with one another. The database 1416 stores information received and/or generated by the central controller 1414. For example, the database 1416 could store the information received from the carts 1402-1406 and allow the information to be retrieved on demand and presented to a fleet manager or other personnel. The database 1416 could also store pre-recorded audio and/or video warnings that may be transmitted to the carts 1402-1406, such as warnings regarding inclement weather or misuse or abuse of the carts 1402-1406. The database 1416 could store any other or additional information. The database 1416 includes any hardware, software, firmware, or combination thereof operable to store and facilitate retrieval of information. The database 1416 may also use any of a variety of data structures, arrangements, and compilations to store and facilitate retrieval of information.

As noted above, in some embodiments, the transceivers 1412 in the carts 1402-1406 may implement a routing or repeating function in the system 1400. In these embodiments, the transceiver 1412 on one of the carts 1402-1406 could receive a message (such as a message from the central controller 1414 or another transceiver 1412). The monitoring system 1410, transceiver 1412, or other component in the cart may determine if the message is intended for that cart. If so, the message may be processed further by the monitoring system 1410 or used in any other suitable manner. If not, the transceiver 1412 could broadcast the message for delivery to the central controller 1408 or another cart. The transceivers 1412 may use the timing mechanisms described above to avoid collusions between communications. In this way, the transceivers 1412 may act as mobile routers in the system 1400.

In this example, only one cart 1402 is in range of and communicates directly with the central controller 1414. Another cart 1406 communicates with the central controller 1414 indirectly through the first cart 1402. In other words, the cart transceiver 1412 in the cart 1402 acts as a mobile router and facilitates communication between the central controller 1414 and the cart 1406.

Instead of or in addition to the transceivers 1412 supporting a routing or repeating function, the system 1400 may include one or more intermediate transmitters 1418. The intermediate transmitters 1418 may be used to transmit information between one or more of the carts 1402-1406 and the central controller 1414. The intermediate transmitter 1418 may, for example, represent a repeater or other device that allows the carts 1402-1406 and the central controller 1414 to communicate over longer distances, such as when the transceiver 1412 in the cart 1404 is incapable of communicating with the central controller 1414. In this example, the cart 1404 communicates indirectly with the central controller 1414 through the intermediate transmitter 1418. The intermediate transmitter 1418 represents any hardware, software, firmware, or combination for transmitting and receiving information, such as an RF repeater.

As shown in FIG. 14, the system 1400 also includes one or more position beacons 1420. The position beacons 1420 broadcast information identifying specific locations in the system 1400. For example, the system 1400 could be located at a golf course, and the position beacons 1420 may identify the various holes in the golf course. The information broadcast by the position beacons 1420 may be received by the monitoring systems 1410 in the carts 1402-1406, and the monitoring systems 1410 could provide the location information to the central controller 1414. This allows the central controller 1414 to identify the locations of the carts 1402-1406. The position beacons 1420 represent any devices capable of broadcasting location information. As a particular example, each position beacon 1420 could include a power source (such as a solar cell or battery), an RF transceiver with an antenna, a memory containing a unique identification code and a location code, and a microprocessor with associated software and/or firmware that broadcasts the unique identification and location code using the transceiver.

Although FIG. 14 illustrates one example of a system 1400 for monitoring use of vehicles, various changes may be made to FIG. 14. For example, while the system 1400 has been described as monitoring various carts 1402-1406, the system 1400 could be used to monitor any other or additional types of vehicles. Also, the system 1400 could include any number of carts 1402-1406, intermediate transmitters 1418, and position beacons 1420. Further, other techniques could be used to track the locations of the carts 1402-1406 instead of or in addition to the use of position beacons 1420, such as global positioning systems (“GPS”). Beyond that, a decentralized controller or other type of controller could be used in place of the central controller 1414. In addition, the intermediate transmitters 1418 may or may not be used in the system 1400, and the transceivers 1412 may or may not support routing or repeating functionality in the system 1400.

FIG. 15 illustrates an example cart 1402 according to one embodiment of this disclosure. The embodiment of the cart 1402 shown in FIG. 15 is for illustration only. Other embodiments of the cart 1402 may be used without departing from the scope of this disclosure.

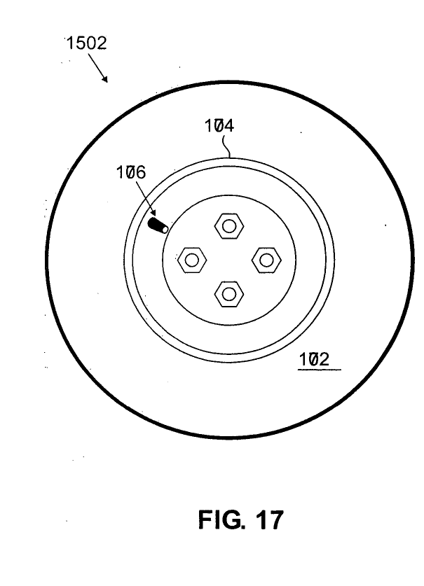

In this example, the cart 1402 includes four tire assemblies 1502-1508, a battery pack 1510, and a motor 1512. The tire assemblies 1502-1508 represent tires and associated structures (such as axles and rims) used to facilitate movement of the cart 1402. One example of the tire assemblies 1502-1508 is shown in FIG. 17, which is described below. In some embodiments, the tire assemblies 1502-1508 include integrated pressure sensors that measure the tire pressures of the tires in the tire assemblies 1502-1508.

The battery pack 1510 provides power to the motor 1512. The battery pack 1510 could also provide power to other components in the cart 1402 shown in FIG. 15. In this example, the battery pack 1510 includes six separate batteries coupled in series. Other embodiments of the cart 1402 may use any number of batteries in any configuration. Also, other embodiments of the cart 1402 may use other or additional power sources.

In this example embodiment, the monitoring system 1410 and the transceiver 1412 are represented by the remaining components in FIG. 15. As shown in FIG. 15, the cart 1402 includes a vehicle command module 1514. The vehicle command module 1514 monitors various characteristics about the cart 1402 and communicates with the central controller 1414. In this embodiment, the vehicle command module 1514 includes a controller 1516, a memory 1518, and an input/output (“I/O”) interface (“I/F”) 1520. The controller 1516 controls the operation of the vehicle command module 1514, such as by generating messages communicated to the central controller 1414 and processing messages and commands received from the central controller 1414. The memory 1518 stores information for the controller 1516, such as instructions executed by the controller 1516 and data used by the controller 1516. The memory 1518 may store other or additional information, such as an identifier uniquely identifying the cart 1402. The I/O interface 1520 provides external access to the vehicle command module 1514. The controller 1516 includes any hardware, software, firmware, or combination thereof for controlling the vehicle command module 1514, such as a microprocessor or microcontroller. The memory 1518 represents any volatile and/or non-volatile storage and retrieval device or devices. The I/O interface 1520 represents any structure providing an interface to the controller 1516.

The vehicle command module 1514 also includes a transceiver 1522 and an antenna 1524. The transceiver 1522 is capable of receiving a signal containing outgoing information from the controller 1516 and up-converting the signal. The transceiver 1522 provides the up-converted signal to the antenna 1524 for transmission. The transceiver 1522 also receives a signal containing incoming information from the antenna 1524, down-converts the signal, and provides the down-converted signal to the controller 1516 for processing. The transceiver 1522 includes any hardware, software, firmware, or combination thereof for preparing signals for transmission and processing received signals. The antenna 1524 represents any structure capable of transmitting and receiving signals. As a particular example, the transceiver 1522 could represent an RF transceiver, and the antenna 1524 could represent an RF antenna.

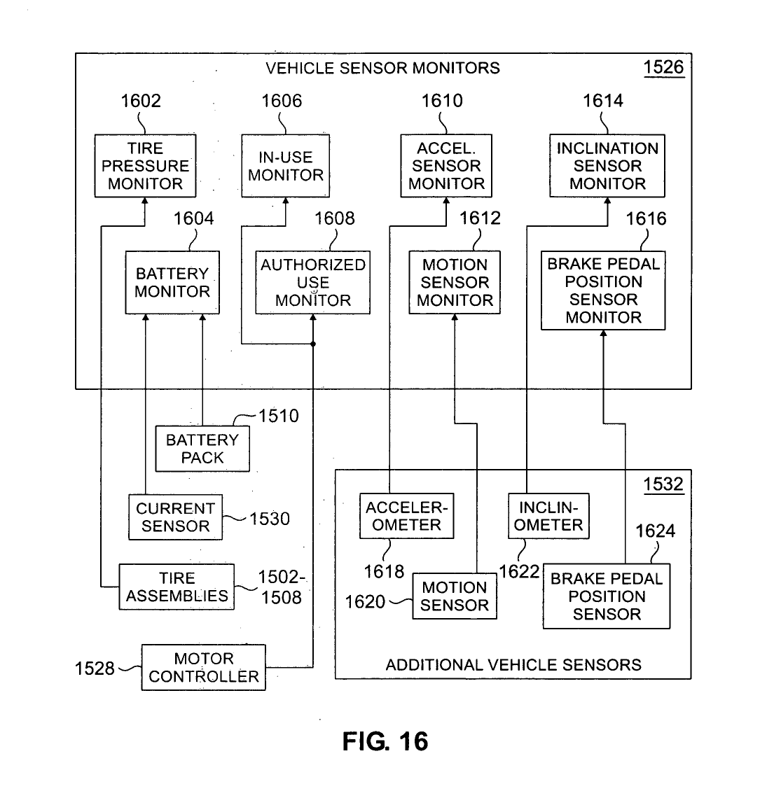

The vehicle command module 1514 further includes one or more vehicle sensor monitors 1526. The vehicle sensor monitors 1526 monitor the output of a motor controller 1528, a current sensor 1530, and various additional vehicle sensors 1532. For example, the motor controller 1528 may indicate when the motor 1512 is activated or deactivated, and the vehicle sensor monitors 1526 monitor this information and inform the controller 1516 when the cart 1402 is in use. As another example, the current sensor 1530 may measure the current provided by the battery pack 1510, and the vehicle sensor monitors 1526 may monitor and provide this information to the controller 1516. In addition, the vehicle sensor monitors 1526 could monitor the outputs of the additional vehicle sensors 1532 and provide this information to the controller 1516. The vehicle sensor monitors 1526 include any hardware, software, firmware, or combination thereof for monitoring one or more vehicle sensors. The motor controller 1528 includes any hardware, software, firmware, or combination thereof for monitoring and controlling the use of the motor 1512. The current sensor 1530 represents any hardware, software, firmware, or combination thereof for monitoring a current from the battery pack 1510. The additional vehicle sensors 1532 include any hardware, software, firmware, or combination thereof for monitoring one or more characteristics of the cart 1402. Additional details of the vehicle sensor monitors 1526 and the additional vehicle sensors 1532 are shown in FIG. 16, which is described below.

As shown in FIG. 15, the vehicle command module 1514 also includes an interface 1534, which facilitates communication between the controller 1516 and one or more input/output devices 1536. The input/output devices 1536 could, for example, include a loudspeaker and a video screen. This allows the controller 1516 to receive information from the central controller 1414 and present the information to people using the cart 1402. As a specific example, this allows the controller 1516 to receive and present a warning to the people using the cart 1402, such as a warning about misuse or abuse of the cart 1402 with an instruction to return the cart 1402 or a warning of inclement weather. As another specific example, this allows the controller 1516 to facilitate two-way communication between the people using the cart and personnel such as a fleet manager. This may allow, for example, a live warning to be provided to the people using the cart 1402 and the people to acknowledge the warning or explain any potential misuse or abuse. The interface 1534 represents any structure providing an interface to the input/output devices 1536. The input/output devices 1536 include any suitable input and/or output devices, such as loudspeakers, monitors, indicator lights, and microphones.

In this example, the cart 1402 also includes an authorization transmitter 1538. The authorization transmitter 1538 represents a transmitter, such as an RF transmitter, that authorizes the use of the cart 1402. For example, the authorization transmitter 1538 could transmit an RF key, and the controller 1516 may verify the RF key and enable use of the cart 1402. The authorization transmitter 1538 could be provided to a person who rents the cart 1402. As a particular example, the authorization transmitter 1538 could authorize the use of the cart 1402 in any circumstance, for a specified length of time, for a specified location or locations, or for a specified number of golf holes. The authorization transmitter 1538 could represent any suitable device, such as an RF tag, a key fob, or other security mechanism. As a particular example, the authorization transmitter 1538 could represent a “bag tag,” or an RF tag that is attached to a golf bag and placed in the cart 1402.

Although FIG. 15 illustrates one example of a cart 1402, various changes may be made to FIG. 15. For example, the functional division in FIG. 15 is for illustration only. Various components in FIG. 15 may be combined or omitted and additional components could be added according to particular needs. As specific examples, various ones of the motor controller 1528, current sensor 1530, and additional sensors 1532 could be omitted depending on the implementation. Also, the cart 1402 need not include the interface 1534 and the input/output devices 1536.

FIG. 16 illustrates additional details of an example cart 1402 according to one embodiment of this disclosure. In particular, FIG. 16 illustrates specific examples of the vehicle sensor monitors 1526 and the additional vehicle sensors 1532 shown in FIG. 15. The details of the cart 1402 shown in FIG. 16 are for illustration only. Other embodiments of the cart 1402 may be used without departing from the scope of this disclosure.

As shown in FIG. 16, the cart 1402 includes various vehicle sensor monitors 1602-1616 and additional vehicle sensors 1618-1624. A tire pressure monitor 1602 monitors the tire pressures of the tires in the tire assemblies 1502-1508 of the cart 1402. As explained below with respect to FIG. 17, the tire assemblies 1502-1508 may each include a wireless transmitter capable of transmitting a tire pressure to the tire pressure monitor 1602. The tire pressure monitor 1602 may then communicate the information from the tire assemblies 1502-1508 to the controller 1516.

A battery monitor 1604 is coupled to each of the batteries in the battery pack 1510 and to the current sensor 1530. The battery monitor 1604 is capable of monitoring various aspects of the battery pack 1510. For example, the battery monitor 1604 could monitor the charge level of each battery in the battery pack 1510. The battery monitor 1604 could also monitor the amount of current output by the battery pack 1510 as measured by the current sensor 1530. This information may be communicated to the controller 1516. In some embodiments, a wiring harness is used to couple the battery monitor 1604 to each battery in the battery pack 1510.

An in-use monitor 1606 and an authorized use monitor 1608 are coupled to the motor controller 1528. The in-use monitor 1606 determines whether the motor 1512 of the cart 1402 is currently running. This enables the in-use monitor 1606 to determine when the cart 1402 is in use and to communicate this information to the controller 1516. The in-use monitor 1606 may use input from the motor controller 1528 or other component, such as a throttle position sensor, to determine when the cart 1402 is in use. The authorized use monitor 1608 determines whether use of the cart 1402 is authorized. For example, the authorized use monitor 1608 may determine whether a valid signal has been received from an authorization transmitter 1538. If use has not been authorized, the motor controller 1528 may be used to disable the motor 1512, and an alert may be transmitted by the controller 1516. The authorized use monitor 1608 may also receive commands from the central controller 1414 to enable or disable the cart 1402, and the authorized use monitor 1608 may use the motor controller 1528 to enable or disable the cart 1402.

An accelerometer sensor monitor 1610 is coupled to an accelerometer 1618. The accelerometer 1618 measures the acceleration of the cart 1402. The accelerometer sensor monitor 1610 monitors the measured acceleration and provides this information to the controller 1516. A motion sensor monitor 1612 is coupled to a motion sensor 1620. The motion sensor 1620 detects movement of the cart 1402, and the motion sensor monitor 1612 monitors the measured motion and provides this information to the controller 1516. An inclination sensor monitor 1614 is coupled to an inclinometer 1622. The inclinometer 1622 measures the inclination of the cart 1402, and the inclination sensor monitor 1614 monitors the measured inclination and provides this information to the controller 1516. A brake pedal position sensor monitor 1616 is coupled to a brake pedal position sensor 1624. The brake pedal position sensor 1624 measures the position of a brake on the cart 1402, such as whether the brake is set or unset. The brake pedal position sensor monitor 1616 monitors the measured brake position and provides this information to the controller 1516.

The information collected by the various sensors and monitors in the cart 1402 may be used by the controller 1516 and/or the central controller 1414 in any suitable manner. The following represents examples of how the information may be used by the central controller 1414. In other embodiments, at least some of the functions described below as being performed by the central controller 1414 could be implemented in the controller 1516 and/or the various sensor monitors 1602-1616. Also, the central controller 1414, controller 1516, and/or sensor monitors 1602-1616 may use the information in any other or additional ways without departing from the scope of this disclosure.

The tire pressure monitor 1602 continuously monitors the tire pressure of each tire on the cart 1402. The central controller 1414 stores this information in the database 1416. The central controller 1414 also identifies the pressure decrease or leak rate of each tire on the cart 1402 and determines the readiness for use of the cart 1402 based on the tire pressures. The central controller 1414 further identifies chronically underperforming tires so that they may be replaced in a timely manner.

The battery monitor 1604 continuously monitors the condition or charge level of the battery pack 1510 and each individual battery within the battery pack 1510. The central controller 1414 stores this information in the database 1416. The central controller 1414 also identifies a performance sag rate for the battery pack 1510 and for each individual battery. The central controller 1414 further determines the readiness of the cart 1402 for use based on the cart's current battery condition. In addition, the central controller 1414 monitors and analyzes the performance and sag rate of the battery pack 1510 and the individual batteries to identify chronically underperforming battery packs 1510 or individual batteries, allowing them to be replaced in a timely manner.

The brake pedal position sensor 1624 and the brake pedal position sensor monitor 1618 monitor the use of the brake on the cart 1402. The central controller 1414 stores this information in the database 1416. The central controller 1414 also monitors the condition of the brakes on the cart 1402, such as by detecting movement of the cart 1402 (through the motion sensor 1620 and the motion sensor monitor 1612) even when the brake is set.

The central controller 1414 may also remotely authorize or disable use of the cart 1402 (instead of or in addition to using the authorization transmitter 1538) or the entire fleet of carts 1402-1406. Authorized use can occur for a fixed length of time, for a fixed number of golf holes or other limited areas, or in any other suitable manner. Carts used beyond the authorized use may be remotely disabled, such as by being disabled automatically by the central controller 1414 or at the discretion of the fleet manager or other personnel. The central controller 1414 could provide a live or pre-recorded audio and/or video announcement warning that authorized use has expired, requesting return of the cart 1402, and warning that the cart 1402 will be disabled after a certain amount of time elapses.

The central controller 1414 may further monitor the average use and cumulative or total use of the cart 1402 through information collected by the in-use monitor 1606. The use of all carts 1402-1406 may be compared and allow the fleet manager or other personnel to identify over-utilized or under-utilized carts. This allows the fleet manager or other personnel to balance the use of the carts 1402-1406, which helps to extend the overall lifetime of the fleet.

Beyond that, the central controller 1414 may monitor cart use and identify abuse. For example, the central controller 1414 may use the information from the acceleration sensor monitor 1610 to detect when the cart 1402 is subjected to excessive speed or a mechanical shock in excess of a predetermined threshold (an excessive change in speed). The event and the location of the cart 1402 may be recorded and an alert transmitted to the appropriate personnel. The central controller 1414 could then provide a live or pre-recorded warning to the cart 1402. Similarly, the central controller 1414 could identify unsafe use of the cart 1402. For example, the central controller 1414 may use the information from the inclination sensor monitor 1614 to identify when the cart 1402 is subjected to a tilting environment in excess of a predetermined threshold. The event and the location of the cart 1402 may be recorded, an alert may be transmitted to the appropriate personnel, and a live or pre-recorded warning may be provided to the cart 1402.

In addition, the central controller 1414 could poll the various carts 1402-1406 and determine whether responses from the carts are received. For example, the controller 1516 in the cart 1402 could receive a poll and generate and transmit a response to the poll. In this way, the central controller 1414 may determine whether any carts are missing and generate alerts accordingly. Also, the controller 1516 in the cart 1402 may be configured so that the cart 1402 is disabled if the controller 1516 fails to receive a poll from the central controller 1414, such as a poll transmitted at regular intervals.

The central controller 1414 could support any other or additional functionality. For example, the central controller 1414 could communicate warnings to the cart 1402 identifying dangerous weather and requesting that the cart 1402 be returned. The central controller 1414 could also track the progress of the cart 1402, such as the progress of the cart 1402 around a golf course. When the controller 1516 in the cart 1402 detects a position beacon 1420 that identifies a location, the controller 1516 may communicate a message identifying the location and the current time to the central controller 1414. The central controller 1414 may use this information to identify gaps between consecutive groups of golfers and communicate a warning to the lagging group requesting that the group speed up its rate of play or allow another group to pass. Further, the central controller 1414 could associate particular users with carts being used and develop profiles for the users, such as snack and drink preferences of the users. When a particular user begins using the cart 1402, snack shop and drink cart operators may be informed of the user's presence and preferences. This allows the operators to ensure that a snack shop, drink cart, or other vendor is properly stocked, to greet the user by name, and to offer the preferred snack or drink without having to ask the user. In addition, the carts 1402-1406 and/or central controller 1414 could interface with existing systems, such as GPS location convenience systems or any other RF-controlled or other systems like irrigation and snack order call-ahead systems.

The information collected, analyzed, and/or generated by the central controller 1414 may be provided to a fleet manager or other personnel in any suitable manner. For example, the information may be provided in an on-demand manner, such as in response to a query from the fleet manager. Also, as described above, the central controller 1414 may generate and communicate alerts to appropriate personnel. The alerts could, for example, represent pre-recorded voice messages, instant messages, or email messages communicated to wireless devices (such as mobile telephones or personal digital assistants) used by the personnel.

The various sensor monitors 1602-1616 have been described above as providing information to the controller 1516 for analysis and/or communication. In other embodiments, the sensor monitors 1602-1616 themselves are capable of analyzing the collected information and communicating alerts to the controller 1516. For example, the tire pressure monitor 1602 could compare measured tire pressures to a threshold and generate an alert if any of the pressures fail below the threshold.

Although FIG. 16 illustrates additional details of one example of a cart 1402, various changes may be made to FIG. 16. For example, any other or additional types of monitors and/or sensors may be used in the cart 1402.

FIG. 17 illustrates an example cart tire assembly 1502 according to one embodiment of this disclosure. The embodiment of the tire assembly 1502 shown in FIG. 17 is for illustration only. Other embodiments of the tire assembly 1502 may be used without departing from the scope of this disclosure.

As shown in FIG. 17, the tire assembly 1502 includes a tire 1702, a rim 1704, and a tire pressure monitoring valve stem 1706. The tire 1702 represents any suitable tire capable of being inflated. The rim 1704 represents any suitable support for the tire 1702.

The valve stem 1706 is capable of allowing the tire 1702 to be inflated and deflated. The valve stem 1706 also includes an integrated pressure sensor and transmitter. The pressure sensor measures the pressure within the tire 1702, and the transmitter transmits the measured pressure to the tire pressure monitor 1602. In this way, the tire pressure monitor 1602 may effectively and efficiently monitor the tire pressure of the tire assemblies 1502-1508.

Although FIG. 17 illustrates one example of a cart tire assembly 1502, various changes may be made to FIG. 17. For example, any other suitable mechanism may be used to monitor tire pressure in the tire assembly 1502.

FIG. 18 illustrates another example cart 1402 according to one embodiment of this disclosure. The embodiment of the cart 1402 shown in FIG. 18 is for illustration only. Other embodiments of the cart 1402 may be used without departing from the scope of this disclosure. Also, the components in the cart 1402 that are common to FIGS. 15 and 18 are given the same reference numerals.

As shown in FIG. 18, the cart 1402 is powered by a motor 1802. The motor 1802 operates using fuel stored in a fuel tank 1804. The motor 1802 represents any suitable fuel-based motor, such as a gasoline-powered combustion engine or a motor powered by a fuel cell. Also, the fuel tank 1804 represents any suitable storage for fuel.

In this example, the cart 1402 includes a fuel level sensor 1806. The fuel level sensor 1806 measures the amount of fuel remaining in the fuel tank 1804. The fuel level sensor 1806 represents any suitable structure or device for measuring the amount of fuel in the fuel tank 1804. For example, the fuel level sensor 1806 may include circuitry that measures the location of a floatation device located in the fuel tank 1804.

The output of the fuel level sensor 1806 is provided to a fuel level sensor monitor 1808, which represents one of the vehicle sensor monitors 1526. The fuel level sensor monitor 1808 may be used in place of the battery monitor 1604. The fuel level sensor monitor 1808 may then analyze the fuel level from the fuel level sensor 1806 and/or communicate the measured fuel level to the controller 1516.

Although FIG. 18 illustrates another example of a cart 1402, various changes may be made to FIG. 15. For example, the functional division in FIG. 18 is for illustration only. Various components in FIG. 18 may be combined or omitted and additional components could be added according to particular needs. Also, the cart 1402 could include both a battery or battery pack 1510 and a motor 1802. Further, the cart 1402 could include any other or additional sources of power.

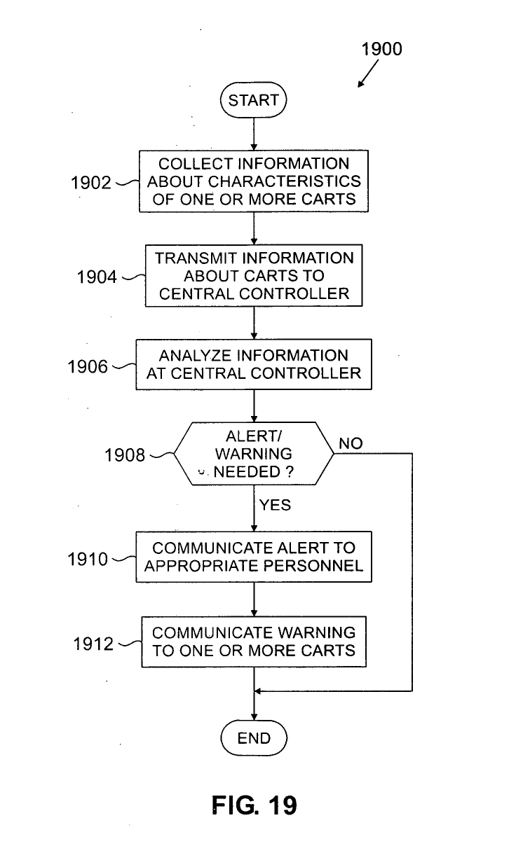

FIG. 19 illustrates an example method 1900 for monitoring use of vehicles according to one embodiment of this disclosure. For ease of explanation, the method 1900 is described with respect to the system 1400 of FIG. 14. The method 1900 could be used by any other suitable system to monitor any other suitable vehicles.

Information about the characteristics of one or more carts 1402-1406 is collected at step 1902. This may include, for example, the monitoring systems 1410 in the carts 1402-1406 collecting information from various cart sensors. As particular examples, this may include the tire pressure monitor 1602, battery monitor 1604, in-use monitor 1606, authorized use monitor 1608, accelerometer sensor monitor 1610, motion sensor monitor 1612, inclination sensor monitor 1614, brake pedal position sensor monitor 1616, and/or fuel level sensor monitor 1808 collecting various information from the sensors and other components in the cart.

The collected information about the carts 1402-1406 is transmitted to a central controller 1414 at step 1904. This may include, for example, the controllers 1516 in the carts 1402-1406 receiving information from the sensor monitors and providing signals containing the information to the transceivers 1522 in the carts 1402-1406. This may also include the transceivers 1522 up-converting the signals and providing the up-converted signals to the antennas 1524 for transmission.

The collected information is analyzed by the central controller 1414 at step 1906. This may include, for example, the central controller 1414 receiving and down-converting the signals received from the carts 1402-1406. This may also include the central controller 1414 extracting the transmitted information from the signals and storing the information in the database 1416. This may further include the central controller 1414 analyzing the information to detect problems with one or more of the carts 1402-1406. Particular examples include determining if one or more tires 1702 in the carts 1402-1406 have a tire pressure that falls below a threshold (under-inflated) or above a threshold (over-inflated), determining if a battery or battery pack 1510 is running low, and determining if a fuel tank 1804 is running low. Other particular examples include estimating the remaining use of a cart 1402 and determining if the current battery or fuel level in the cart 1402 is sufficient for the remaining use. Still other particular examples include analyzing the information to determine if current use of a cart 1402 is authorized and to determine if current use of the cart 1402 is abusive.

A determination is made as to whether an alert and/or a warning is needed at step 1908. This may include, for example, the central controller 1414 determining whether any problems with the carts 1402-1406 have been detected. If no problems have been detected, the method 1900 ends. At this point, the carts 1402-1406 may continue collecting information that is provided to the central controller 1414.

Otherwise, if a problem has been identified for at least one of the carts 1402-1406, at least one alert is communicated to the appropriate personnel at step 1910. This may include, for example, the central controller 1414 communicating an instant message, email message, or voice message to a portable electronic device used by a fleet manager or other personnel. At least one warning is communicated to one or more of the carts 1402-1406 at step 1912. This may include, for example, the central controller 1414 communicating a pre-recorded or live message to one or more of the carts 1402-1406. The message may request return of a cart, warn of inclement weather, warn that abusive use has been detected and additional abuse will result in disablement of the cart, or other suitable message. Other information, such as a command to disable the cart, may also be communicated to a cart in the system 1400.

Although FIG. 19 illustrates one example of a method 1900 for monitoring use of vehicles, various changes may be made to FIG. 19. For example, the information from the carts 1402-1406 may be used in any other suitable manner. Also, the central controller 1414 and the carts 1402-1406 may perform any other suitable functions, such as polling the carts 1402-1406 and attempting to disable any carts that fail to respond or receive the polling.

It may be advantageous to set forth definitions of certain words and phrases that have been used within this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, software, firmware, or combination thereof. It should be noted that the functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A vehicle, comprising:
a monitoring system capable of monitoring one or more measurable characteristics associated with the vehicle; and
a transceiver capable of broadcasting information associated with the one or more measurable characteristics for delivery to a controller, the transceiver also capable of receiving information from at least one of the controller and another vehicle and broadcasting the received information for delivery to a destination other than the vehicle.

2. The vehicle of claim 1, wherein at least one of the monitoring system and the controller is capable of identifying one or more problems with the vehicle using the information associated with the one or more measurable characteristics.

3. The vehicle of claim 2, wherein the information associated with the one or more measurable characteristics comprises information associated with at least one of: a tire pressure of one or more tires, a charge level of one or more batteries, a current level supplied by the one or more batteries, a fuel level in a fuel tank, a position of a brake pedal, and movement of the vehicle.

4. The vehicle of claim 3, wherein the one or more problems comprise at least one of: under-inflation of one or more tires, over-inflation of one or more tires, a low charge level of one or more batteries, a low current level supplied by the one or more batteries, a low fuel level in the fuel tank, and movement of the vehicle when the brake pedal is set.

5. The vehicle of claim 2, wherein the information associated with the one or more measurable characteristics comprises information associated with at least one of: an acceleration of the vehicle, an inclination of the vehicle, and a position of a brake pedal.

6. The vehicle of claim 5, wherein the one or more problems comprise abuse of the vehicle, the abuse associated with at least one of: an excessive speed of the vehicle, an excessive change in speed of the vehicle, an excessive inclination of the vehicle, and failure to use the brake pedal.

7. The vehicle of claim 2, wherein the information associated with the one or more measurable characteristics comprises information identifying at least one of: whether the vehicle is currently in use and whether authorization for use of the vehicle has been received.

8. The vehicle of claim 7, wherein the one or more problems comprise misuse of the vehicle, the misuse associated with at least one of: use of the vehicle that is unauthorized and previously authorized use of the vehicle that becomes unauthorized.

9. The vehicle of claim 1, wherein the monitoring system comprises:
a plurality of sensors capable of measuring the one or more measurable characteristics associated with the vehicle; and
a plurality of sensor monitors capable of monitoring the one or more measurable characteristics measured by the plurality of sensors.

10. The vehicle of claim 9, wherein the monitoring system further comprises:
a vehicle command module controller coupled to the sensor monitors and capable of controlling the broadcasting of the information.

11. The vehicle of claim 10, wherein the information associated with the one or more measurable characteristics comprises at least one of:
information collected by the vehicle command module controller from the sensor monitors;
information generated by the sensor monitors; and
information generated by the vehicle command module controller.

12. The vehicle of claim 9, wherein the monitoring system further comprises:
a motor controller capable of enabling and disabling operation of a motor in the vehicle.

13. The vehicle of claim 1, wherein the information associated with the one or more measurable characteristics comprises location information received from a position beacon, the position beacon capable of broadcasting the location information.

14. The vehicle of claim 1, further comprising a controller capable of receiving at least one of: a command to authorize use of the vehicle and a command to disable use of the vehicle.

15. The vehicle of claim 14, wherein at least one of the command to authorize use and the command to disable use originates at one or more of: a central controller and a portable transmitter.

16. The vehicle of claim 14, wherein the command to authorize use comprises an authorization for at least one of: a specified length of time, a specified location or locations, and a specified number of golf holes.

17. The vehicle of claim 14, wherein the controller is further capable of presenting an announcement to a user of the vehicle indicating that authorized use of the vehicle has been exceeded.

18. The vehicle of claim 1, further comprising a controller capable of presenting an announcement to a user of the vehicle, the announcement indicating at least one of:
the vehicle has been subjected to an excessive mechanical shock;
the vehicle has been subjected to an excessive tilting environment in excess of a threshold; and
dangerous weather conditions exist and the user must return to the vehicle to a designated location.

19. The vehicle of claim 18, wherein a location of the vehicle is recorded when the vehicle has been subjected to the excessive mechanical shock or the excessive tilting environment.

20. The vehicle of claim 1, wherein the vehicle comprises a golf cart.

21. A method, comprising:
monitoring one or more measurable characteristics associated with a vehicle;
broadcasting information associated with the one or more measurable characteristics at the vehicle for delivery to a controller;
receiving information at the vehicle from at least one of the controller and another vehicle; and
broadcasting the received information at the vehicle for delivery to a destination other than the vehicle.

22. The method of claim 21, further comprising identifying one or more problems with the vehicle using the information associated with the one or more measurable characteristics.

23. The method of claim 22, wherein the information associated with the one or more measurable characteristics comprises information associated with at least one of: a tire pressure of one or more tires, a charge level of one or more batteries, a current level supplied by the one or more batteries, a fuel level in a fuel tank, a position of a brake pedal, and movement of the vehicle.

24. The method of claim 23, wherein the one or more problems comprise at least one of: under-inflation of one or more tires, over-inflation of one or more tires, a low charge level of one or more batteries, a low current level supplied by the one or more batteries, a low fuel level in the fuel tank, and movement of the vehicle when the brake pedal is set.

25. The method of claim 22, wherein the information associated with the one or more measurable characteristics comprises information associated with at least one of: an acceleration of the vehicle, an inclination of the vehicle, and a position of a brake pedal.

26. The method of claim 25, wherein the one or more problems comprise abuse of the vehicle, the abuse associated with at least one of: an excessive speed of the vehicle, an excessive change in speed of the vehicle, an excessive inclination of the vehicle, and failure to use the brake pedal.

27. The method of claim 22, wherein the information associated with the one or more measurable characteristics comprises information identifying at least one of: whether the vehicle is currently in use and whether authorization for use of the vehicle has been received.

28. The method of claim 27, wherein the one or more problems comprise misuse of the vehicle, the misuse associated with at least one of: use of the vehicle that is unauthorized and previously authorized use of the vehicle that becomes unauthorized.

29. The method of claim 21, wherein the information associated with the one or more measurable characteristics comprises at least one of:
information collected by a vehicle command module controller from a plurality of sensor monitors;
information generated by the sensor monitors; and
information generated by the vehicle command module controller.

30. The method of claim 21, further comprising enabling and disabling operation of a motor in the vehicle based on the one or more measurable characteristics.

31. The method of claim 21, wherein the information associated with the one or more measurable characteristics comprises location information received from a position beacon, the position beacon capable of broadcasting the location information.

32. The method of claim 31, further comprising:
monitoring when multiple vehicles pass the position beacon, the position beacon located on a golf course;
identifying an excessive gap between two of the vehicles; and
providing an announcement to a user of the vehicle causing the gap, the announcement requesting that the user increase a rate of play or allow another vehicle to pass.

33. The method of claim 21, further comprising:
monitoring when the vehicle is in use;
comparing an amount of usage of the vehicle with an amount of usage of other vehicles to identify over-utilized and under-utilized vehicles; and
balancing the usage of the vehicles.

34. The method of claim 21, further comprising:
developing a profile identifying snack and drink preferences of a user of the vehicle; and
informing a vendor that the user is present so that the vendor at least one of: properly stocks a shop or cart, greets the user by name, and offers the user a preferred snack or drink.

35. The method of claim 21, further comprising interfacing the vehicle with at least one of: a global positioning system (“GPS”) location convenience system at a golf course and a radio frequency (“RF”) controlled system at the golf course.

36. The method of claim 21, wherein the vehicle comprises a golf cart.

37. A computer program embodied on a computer readable medium and operable to be executed by a processor, the computer program comprising computer readable program code for:
monitoring one or more measurable characteristics associated with a vehicle;
broadcasting information associated with the one or more measurable characteristics at the vehicle for delivery to a controller;
receiving information at the vehicle from at least one of the controller and another vehicle; and
broadcasting the received information at the vehicle for delivery to a destination other than the vehicle.

38. A vehicle, comprising:
a transceiver capable of broadcasting information associated with one or more measurable characteristics of the vehicle for delivery to a controller; and
a monitoring system capable of monitoring the one or more measurable characteristics, the monitoring system comprising:
a plurality of sensors capable of measuring the one or more measurable characteristics associated with the vehicle;
a plurality of sensor monitors capable of monitoring the one or more measurable characteristics measured by the plurality of sensors;
a vehicle command module controller coupled to the sensor monitors and capable of controlling the broadcasting of the information; and
a motor controller capable of enabling and disabling operation of a motor in the vehicle;
wherein the information associated with the one or more measurable characteristics is capable of identifying one or more problems with the vehicle, misuse of the vehicle, and abuse of the vehicle.
